(19) United States
(12) Patent Application Publication
(10) Pub. No.: US 2025/0119181 A1
(43) Pub. Date: Apr. 10, 2025

(54) RECONFIGURABLE INTELLIGENT SURFACE (RIS) FOR REPETITION OF SIGNAL TRANSMISSIONS

(71) Applicant: QUALCOMM Incorporated, San Diego, CA (US)

(72) Inventors: Saeid SAHRAEI, San Diego, CA (US); Hung Dinh LY, San Diego, CA (US); Yu ZHANG, San Diego, CA (US); Wanshi CHEN, San Diego, CA (US); Krishna Kiran MUKKAVILLI, San Diego, CA (US)

(21) Appl. No.: 18/293,471

(22) PCT Filed: Oct. 1, 2021
(86) PCT No.: PCT/CN2021/122488

§ 371 Date: Jan. 30, 2024

(51) Int. Cl. H04B 7/04; H04B 7/06; H04W 72/1263

(52) U.S. Cl. CPC H04B 7/04013; H04B 7/06968; H04W 72/1263

(57) ABSTRACT

An apparatus for wireless communication is provided. The apparatus may be a user equipment (UE). The apparatus receives a first number of repetitions of a signal transmission from a base station and receives a second number of repetitions of the signal transmission transmitted from a reconfigurable intelligent surface device. The apparatus decodes the signal transmission based at least in part on the first number of repetitions of the signal transmission from the base station and the second number of repetitions of the signal transmission transmitted from the reconfigurable intelligent surface device.

### BACKGROUND

### Technical Field

The present disclosure relates generally to communication systems, and more particularly, to a reconfigurable intelligent surface (RIS) for repetition of signal transmissions.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus receives a first number of repetitions of a signal transmission from a base station, receives a second number of repetitions of the signal transmission transmitted from a reconfigurable intelligent surface device, and decodes the signal transmission based at least in part on the first number of repetitions of the signal transmission from the base station and the second number of repetitions of the signal transmission transmitted from the reconfigurable intelligent surface device.

In an aspect of the disclosure, a computer-readable medium storing computer executable code is provided. The code when executed by a processor cause the processor to: receive a first number of repetitions of a signal transmission from a base station, receive a second number of repetitions of the signal transmission transmitted from a reconfigurable intelligent surface device, and decode the signal transmission based at least in part on the first number of repetitions of the signal transmission from the base station and the second number of repetitions of the signal transmission transmitted from the reconfigurable intelligent surface device.

In an aspect of the disclosure, a method, a computer-readable medium, and an apparatus are provided. The apparatus may be a reconfigurable intelligent surface (RIS) device. The apparatus receives a first number of repetitions of a signal transmission from a base station; and transmits a second number of repetitions of the signal transmission to a user equipment (UE) via the reconfigurable intelligent surface.

In an aspect of the disclosure, a computer-readable medium storing computer executable code is provided. The code when executed by a processor cause the processor to: receive a first number of repetitions of a signal transmission from a base station; and transmit a second number of repetitions of the signal transmission to a user equipment (UE) via the reconfigurable intelligent surface.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating a wireless communication network including a first UE in communication with a first base station via a first beam, and a second UE in communication with a second base station via a second beam.

FIG. 5 is a diagram illustrating a wireless communication network including a base station, a reconfigurable intelligent surface (RIS), a first UE, and a second UE.

FIG. 6 (including FIGS. 6A and 6B) illustrates repetition of an uplink signal transmission in a wireless communication network.

FIG. 7 (including FIGS. 7A, 7B, and 7C) illustrates repetition of a downlink signal transmission in a wireless communication network.

FIG. 8 illustrates a wireless communication network including a base station, a UE, and a reconfigurable intelligent surface (RIS) device in accordance with various aspects of the disclosure.

FIG. 9 (including FIGS. 9A and 9B) illustrates repetition of an uplink signal transmission in the wireless communication network in accordance with various aspects of the disclosure.

FIG. 10 illustrates a signal flow diagram in accordance with various aspects of the disclosure.

FIG. 11 (including FIGS. 11A, 11B, and 11C) illustrates repetition of a downlink signal transmission in a wireless communication network in accordance with various aspects of the disclosure.

FIG. 12 is a signal flow diagram in accordance with various aspects of the present disclosure.

FIG. 13 (including FIGS. 13A and 13B) is a diagram illustrating a wireless communication network including a base station, a UE, and a reconfigurable intelligent surface (RIS) device in accordance with various aspects of the disclosure.

FIG. 14 (including FIGS. 14A and 14B) is a diagram illustrating a wireless communication network including a base station, a UE, and a reconfigurable intelligent surface (RIS) device in accordance with various aspects of the disclosure.

FIG. 15 is a diagram illustrating a number of contiguous slots in accordance with various aspects of the disclosure.

FIG. 16 is a diagram illustrating a consecutive repetition pattern where repetitions of a signal transmission from a base station are scheduled in a first consecutive order, and repetitions of a signal transmission from the reconfigurable intelligent surface (RIS) device are scheduled in a second consecutive order.

FIG. 17 is a diagram illustrating a illustrates a sequence of slots 1700 indicating an example application of network configured time gaps at a UE (e.g., the UE 804)

FIG. 18 is a diagram illustrating a sequence of symbols.

FIG. 19 is a diagram illustrating a sequence of symbols.

FIG. 20 is a diagram illustrating a number of contiguous slots in accordance with various aspects of the disclosure.

FIG. 21 illustrates a signal flow diagram in accordance with various aspects of the disclosure.

FIG. 22 illustrates a signal flow diagram in accordance with various aspects of the disclosure.

FIG. 23 (including FIGS. 23A and 23B) is a diagram illustrating example multiple-input and multiple-output (MIMO) transmissions in a wireless communication network in accordance with various aspects of the disclosure.

FIG. 24 illustrates a signal flow diagram in accordance with various aspects of the disclosure.

FIG. 25 (including FIGS. 25A and 25B) illustrates repetition of an uplink signal transmission in a wireless communication network in accordance with various aspects of the disclosure.

FIG. 26 is a flowchart of a method of wireless communication.

FIG. 27 (including FIGS. 27A and 27B) is a flowchart of a method of wireless communication.

FIG. 28 is a flowchart of a method of wireless communication.

FIG. 29 is a conceptual data flow diagram illustrating the data flow between different means/components in an example apparatus.

FIG. 30 is a diagram illustrating an example of a hardware implementation for an apparatus employing a processing system.

FIG. 31 is a flowchart of a method of wireless communication.

FIG. 32 is a flowchart of a method of wireless communication.

FIG. 33 is a conceptual data flow diagram illustrating the data flow between different means/components in an example apparatus.

FIG. 34 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

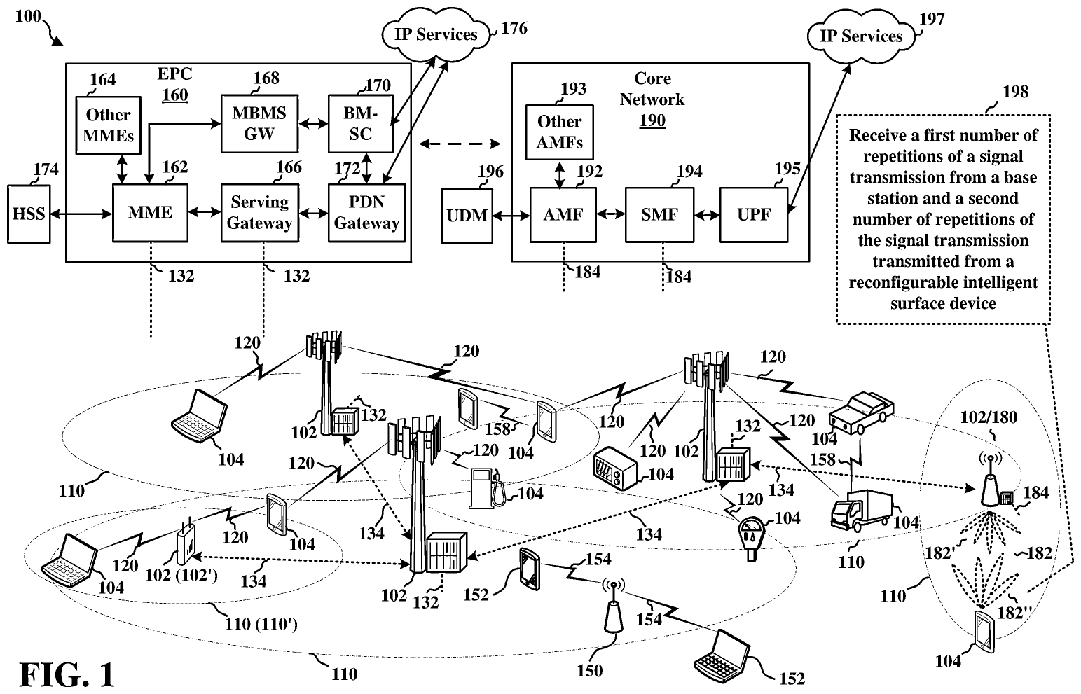

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to receive a first number of repetitions of a signal transmission from a base station and a second number of repetitions of the signal transmission transmitted from a reconfigurable intelligent surface device (198). Although the following description may be focused on 5G NR, the concepts described herein may be applicable to other similar areas, such as LTE, LTE-A, CDMA, GSM, and other wireless technologies.

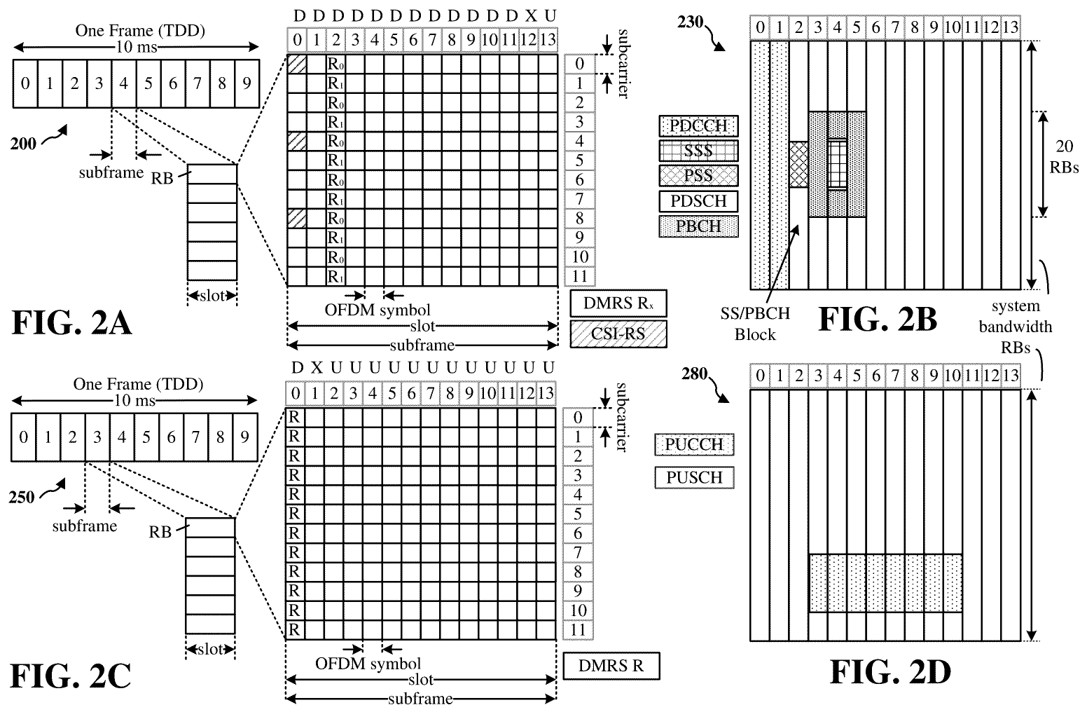

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

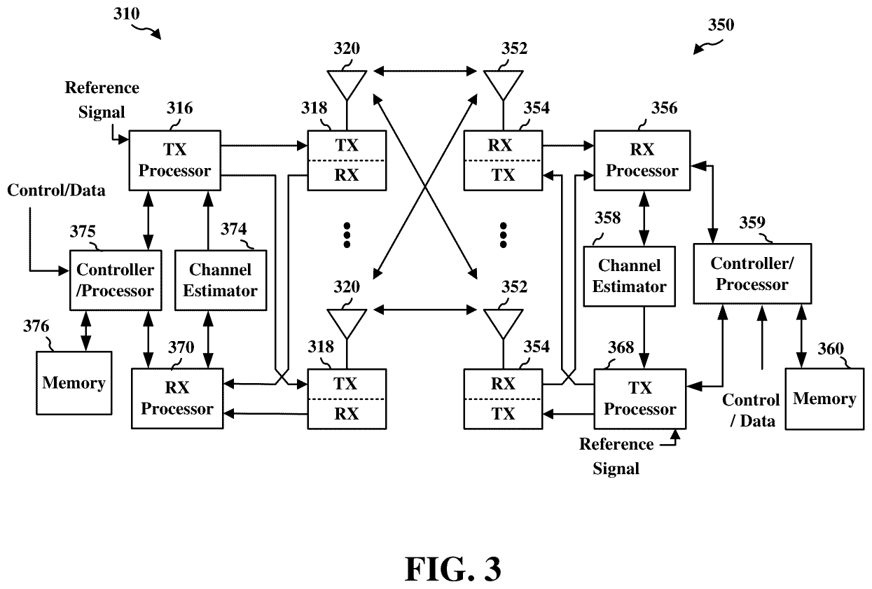

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Wireless communication networks may increase throughput by implementing multiple-input and multiple-output (MIMO) technology, such as massive MIMO in 5G NR networks. Massive MIMO may employ a large number (e.g., massive) of phase and/or amplitude controllable antennas. Massive MIMO may employ active antenna units (AAUs) to achieve high beamforming gain and may include individual RF chains for each of a set of antenna ports. The use of active antenna units, however, may significantly increase power consumption.

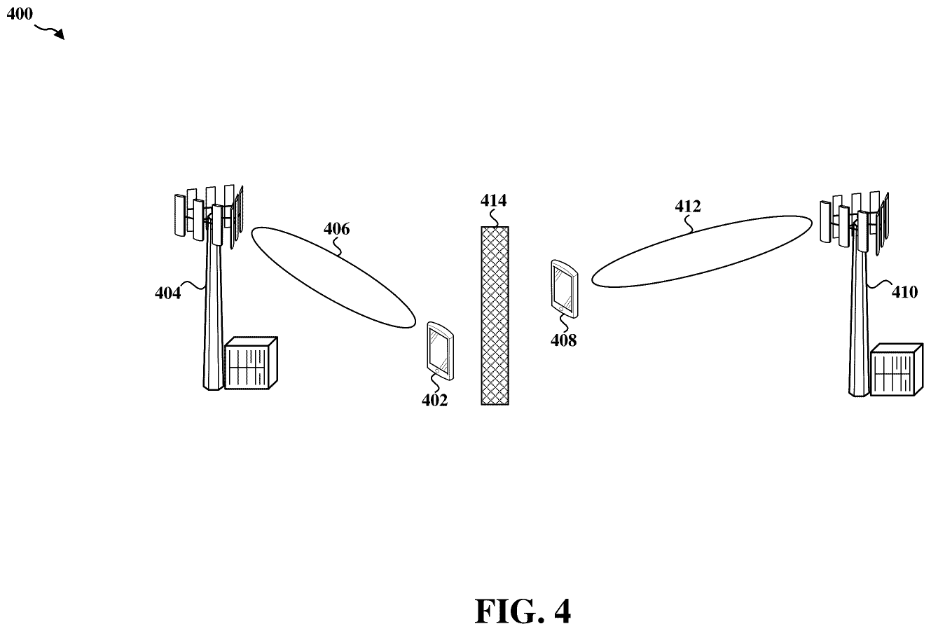

FIG. 4 is a diagram illustrating a wireless communication network 400 including a first UE 402 in communication with a first base station 404 via a first beam 406, and a second UE 408 in communication with a second base station 410 via a second beam 412. In some examples, the wireless communication network 400 may employ massive MIMO. As shown in FIG. 4, an obstacle 414 may be situated between the first and second UEs 402, 408. For example, the obstacle 414 may represent an object or structure, such as a concrete wall, that blocks or attenuates wireless communication signals (e.g., RF signals).

The obstacle 414 may prevent a single base station (e.g., the first base station 404 or the second base station 410) from serving both the first and second UEs 402, 408. For example, the obstacle 414 may prevent the first base station 404 from communicating with the second UE 408 and may prevent the second base station 410 from communicating the first UE 402. Therefore, since two base stations are used to serve the first and second UEs 402, 408 in FIG. 4, the wireless communication network 400 may consume more power and network resources.

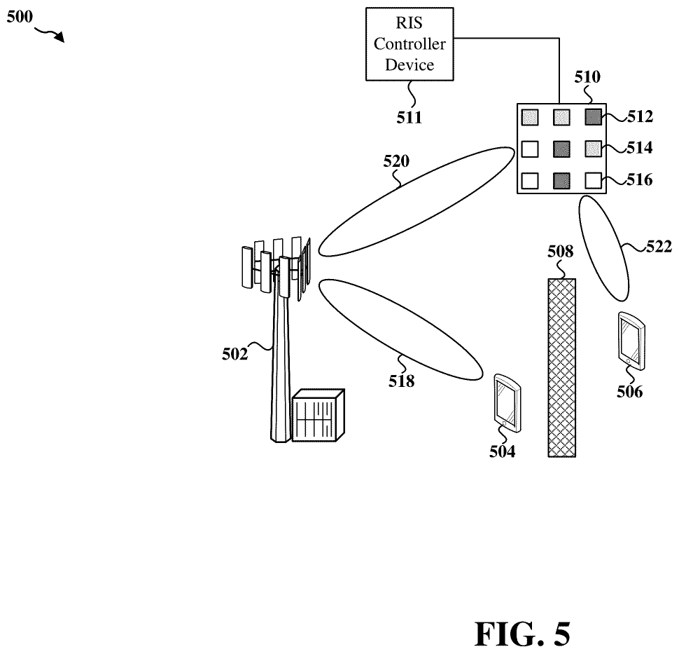

FIG. 5 is a diagram illustrating a wireless communication network 500 including a base station 502, a reconfigurable intelligent surface (RIS) 510, a first UE 504, and a second UE 506. In the wireless communication network 500, the first UE 504 is in communication with the base station 502 via a first beam 518.

As shown in FIG. 5, an obstacle 508 may be situated between the first and second UEs 504, 506. For example, the obstacle 508 may represent an object or structure, such as a concrete wall, that blocks or attenuates wireless communication signals (e.g., RF signals). In some scenarios, the obstacle 508 may block one or more signal propagation paths between the base station 502 and the second UE 506. In these scenarios, no adequate radio channel may exist between the base station 502 and the second UE 506.

In some examples, the RIS 510 may include a grid of reflective elements, such as the reflective elements 512, 514, 516. In some examples, the RIS 510 may not include active antenna units. Therefore, the RIS 510 may be generally considered a passive device and may have negligible power consumption. Each of the reflective elements of the RIS 510 may be configured to reflect incident signals (e.g., beamformed radio frequency (RF) signals) in a desired direction. For example, the reflective elements of the RIS 510 may be electrically configured via a reconfigurable intelligent surface (RIS) controller device 511. In some examples, the base station 502 may control the RIS controller device 511 to reflect incident beams from the base station 502 in a desired direction.

As shown in FIG. 5, the RIS 510 may extend the coverage of the base station 502 by enabling the base station 502 to communicate with the second UE 506 via a second beam 520 and a third beam 522. In some examples, the reflective elements of the RIS 510 may be configured to reflect the second beam 520 (also referred to as an incident beam) in the direction of the second UE 506 to form the third beam 522 (also referred to as a reflected beam).

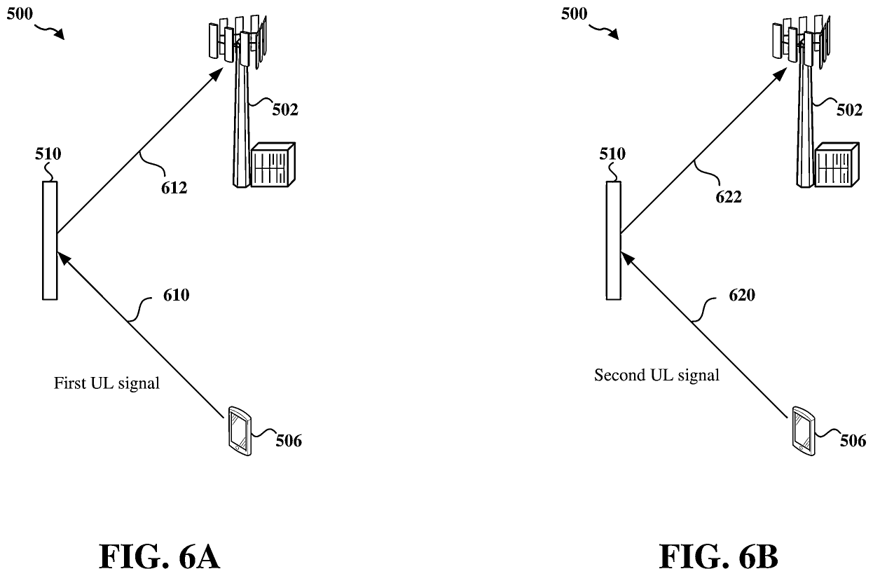

FIG. 6 (including FIGS. 6A and 6B) illustrates repetition of an uplink signal transmission in the wireless communication network 500. In some scenarios, the second UE 506 may transmit an uplink signal multiple times for successful reception and/or decoding at the base station 502. For example, as shown in FIG. 6A, the second UE 506 may transmit a first uplink signal 610 toward the RIS 510. The RIS 510 may be configured to reflect the first uplink signal 610 toward the base station 502 as indicated in FIG. 6A with the reflected uplink signal 612. In some examples, with reference to FIG. 5, the second UE 506 may transmit the first uplink signal 610 using the third beam 522. In some examples, with reference to FIG. 5, the RIS 510 may reflect the first uplink signal 610 toward the base station 502 using the second beam 520.

As shown in FIG. 6B, the second UE 506 may transmit a second uplink signal 620 toward the RIS 510. The second uplink signal 620 may be a repetition (e.g., retransmission) of the first uplink signal 610. The RIS 510 may be configured to reflect the second uplink signal 620 toward the base station 502 as indicated in FIG. 6B with the reflected uplink signal 622. In some examples, with reference to FIG. 5, the second UE 506 may transmit the second uplink signal 620 using the third beam 522. In some examples, with reference to FIG. 5, the RIS 510 may reflect the second uplink signal 620 toward the base station 502 using the second beam 520.

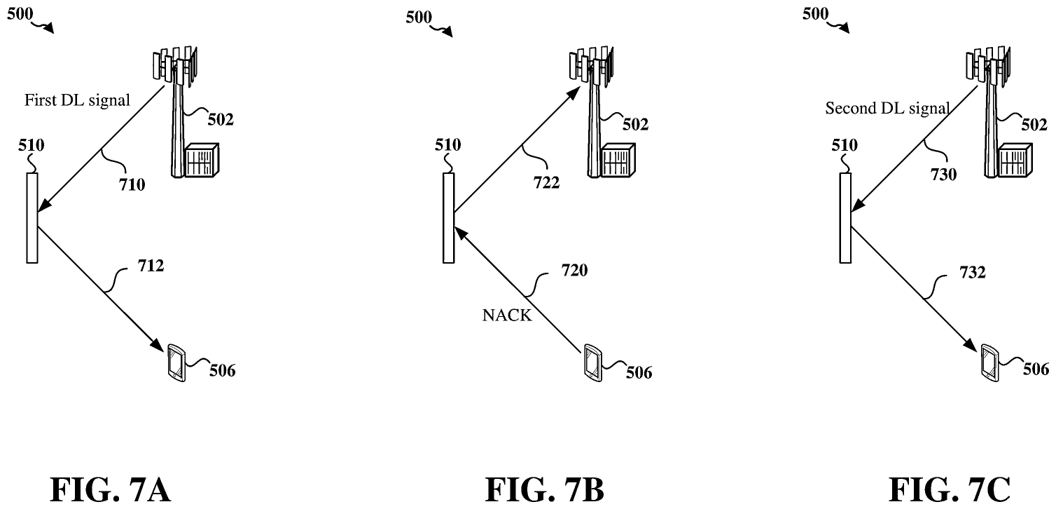

FIG. 7 (including FIGS. 7A, 7B, and 7C) illustrates repetition of a downlink signal transmission in the wireless communication network 500. In some scenarios, the base station 502 may transmit a downlink signal multiple times for successful reception and/or decoding at the second UE 506. For example, as shown in FIG. 7A, the base station 502 may transmit a first downlink signal 710 toward the RIS 510. For example, the first downlink signal 710 may be a data transmission in a data channel (e.g., PDSCH). The RIS 510 may be configured to reflect the first downlink signal 710 toward the second UE 506 as indicated in FIG. 7A with the reflected downlink signal 712. In some examples, with reference to FIG. 5, the base station 502 may transmit the first downlink signal 710 using the second beam 520. In some examples, with reference to FIG. 5, the RIS 510 may reflect the first downlink signal 710 toward the second UE 506 using the third beam 522.

In some scenarios, the second UE 506 may not be able to decode the reflected downlink signal 712 and may transmit a negative acknowledgement (NACK) signal 720 toward the RIS 510. The RIS 510 may be configured to reflect the NACK signal 720 toward the base station 502 as indicated in FIG. 7B with the reflected NACK signal 722. In some examples, with reference to FIG. 5, the second UE 506 may transmit the NACK signal 720 using the third beam 522. In some examples, with reference to FIG. 5, the RIS 510 may reflect the NACK signal 720 toward the base station 502 using the second beam 520.

As shown in FIG. 7C, the base station 502 may transmit a second downlink signal 730 toward the RIS 510. The second downlink signal 730 may be a repetition (e.g., retransmission) of the first downlink signal 710. The RIS 510 may be configured to reflect the second downlink signal 730 toward the second UE 506 as indicated in FIG. 7C with the reflected signal 732. In some examples, with reference to FIG. 5, the base station 502 may transmit the second downlink signal 730 using the second beam 520. In some examples, with reference to FIG. 5, the RIS 510 may reflect the second downlink signal 730 toward the second UE 506 using the third beam 522.

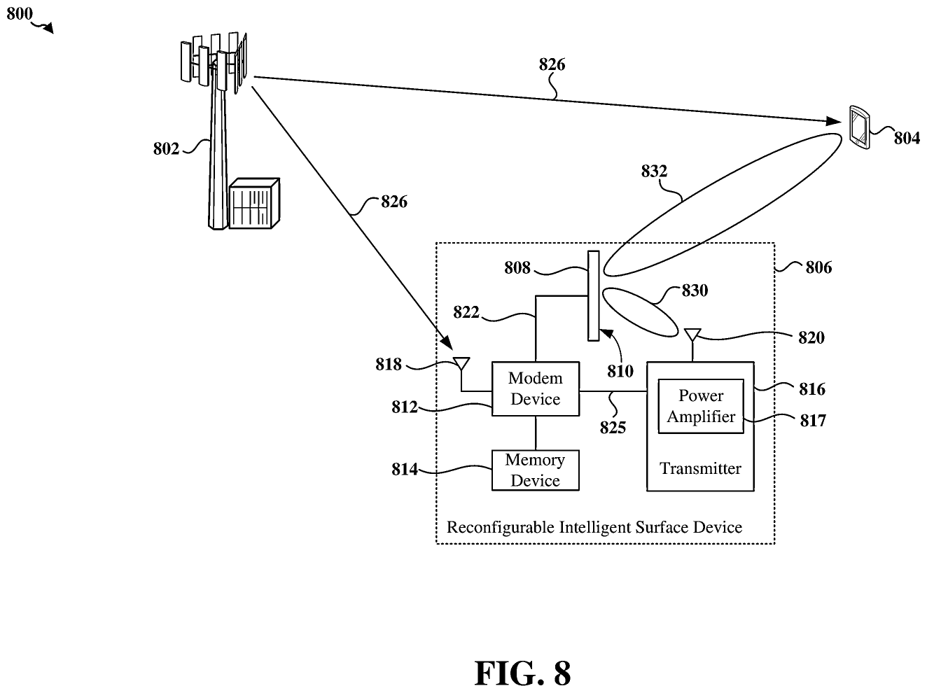

FIG. 8 illustrates a wireless communication network 800 including a base station 802, a UE 804, and a reconfigurable intelligent surface (RIS) device 806 in accordance with various aspects of the present disclosure. In some aspects of the disclosure, the RIS device 806 may include a reconfigurable intelligent surface (RIS) 808, a modem device 812, a memory device 814, and a transmitter 816. In some examples, the RIS device 806 may further include one or more reception antennas (e.g., reception antenna 818) coupled to the modem device 812, and one or more transmission antennas (e.g., transmission antenna 820) coupled to the transmitter 816.

The modem device 812 may electronically configure the RIS 808 to reflect incident signal transmissions (e.g., beamformed radio frequency (RF) signals) in a desired direction. For example, the modem device 812 may output control information to the RIS 808 through the conductive path 822. The control information may tune the reflective elements of the RIS 808 to reflect incident signal transmissions on the surface 810 in a desired direction.

The transmitter 816 may be configured to transmit signals from the transmission antenna 820. In some examples, the transmitter 816 may include a power amplifier (PA) 817 and may transmit beamformed RF signals toward the surface 810 of the RIS 808. In some aspects of the disclosure, the power amplifier 817 may be a low-power power amplifier. In some examples, the power amplifier 817 may consume substantially less power than a power amplifier implemented at the base station 802.

In the wireless communication network 800, the base station 802 may transmit a downlink signal 826 to the UE 804. The modem device 812 may receive the downlink signal 826 via the reception antenna 818 and may sample the downlink signal 826. In some examples, the modem device 812 may obtain in-phase and quadrature (IQ) signal information from the sampled downlink signal transmission 826 and may store the in-phase and quadrature signal information in the memory device 814.

In some examples, the modem device 812 may retrieve the stored in-phase and quadrature signal information from the memory device 814 and may provide the in-phase and quadrature signal information to the transmitter 816 via the conductive path 825. The transmitter 816 may transmit a signal transmission via the transmission antenna 820 based on the in-phase and quadrature signal information. Therefore, the signal transmission via the transmission antenna 820 may effectively serve as a repetition (e.g., retransmission) of the downlink signal 826.

In one example, the signal transmission from the transmitter 816 may be transmitted toward the surface 810 of the RIS 808 via the transmission antenna 820 using a first beam 830. The RIS 808 may be configured to reflect the beam 830 in the direction of the UE 804 via a second beam 832.

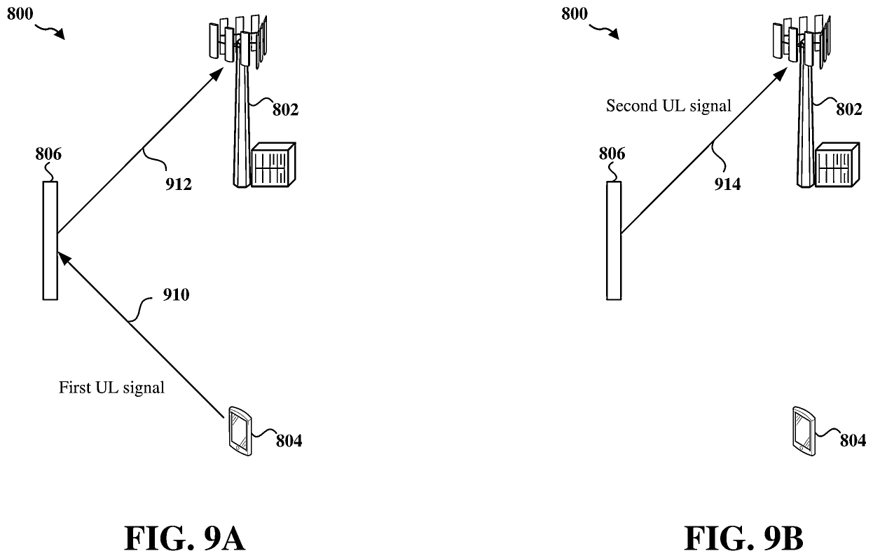

FIG. 9 (including FIGS. 9A and 9B) illustrates repetition of an uplink signal transmission in the wireless communication network 800 in accordance with various aspects of the present disclosure. In some scenarios, the UE 804 may transmit an uplink signal multiple times for successful reception and/or decoding at the base station 802. In the aspects described herein with reference to FIG. 9, repetitions of an uplink signal from the UE 804 may be delegated to the RIS device 806.

For example, as shown in FIG. 9A, the UE 804 may transmit a first uplink signal 910 toward the RIS device 806. The RIS device 806 may be configured to reflect the first uplink signal 910 toward the base station 802 as indicated in FIG. 9A with the reflected first uplink signal 912. The RIS device 806 may be further configured to sample the first uplink signal 910 and store in-phase and quadrature signal information for subsequent retransmission of the first uplink signal 910.

As shown in FIG. 9B, the RIS device 806 may transmit a second uplink signal 914 toward the base station 802. The second uplink signal 914 may be a repetition (e.g., retransmission) of the first uplink signal 910 based on the previously stored in-phase and quadrature signal information of the first uplink signal 910. For example, the RIS device 806 may be configured to transmit (e.g., via the transmission antenna 820) the second uplink signal 914 toward the surface 810 of the RIS device 806. The RIS 808 of the RIS device 806 may be configured to reflect the second uplink signal 914 toward the base station 802. Accordingly, while the reflected first uplink signal 912 is a signal that was originally transmitted from UE 804 and reflected by surface 810 (e.g., without or independent of being received by reception antenna 818), the second UL signal 914 is originally transmitted from RIS device 806 via transmission antenna 820 based on sampling, storing, and/or processing a previously received signal from UE 804 via reception antenna 818.

Thus, the RIS device 806 transmitting the second uplink signal 914 to the base station 802 may keep resources for the UE 804 available that would otherwise be used to retransmit the first uplink signal 910. Additionally, the UE 804 may conserve power that would otherwise be used to retransmit the first uplink signal 910.

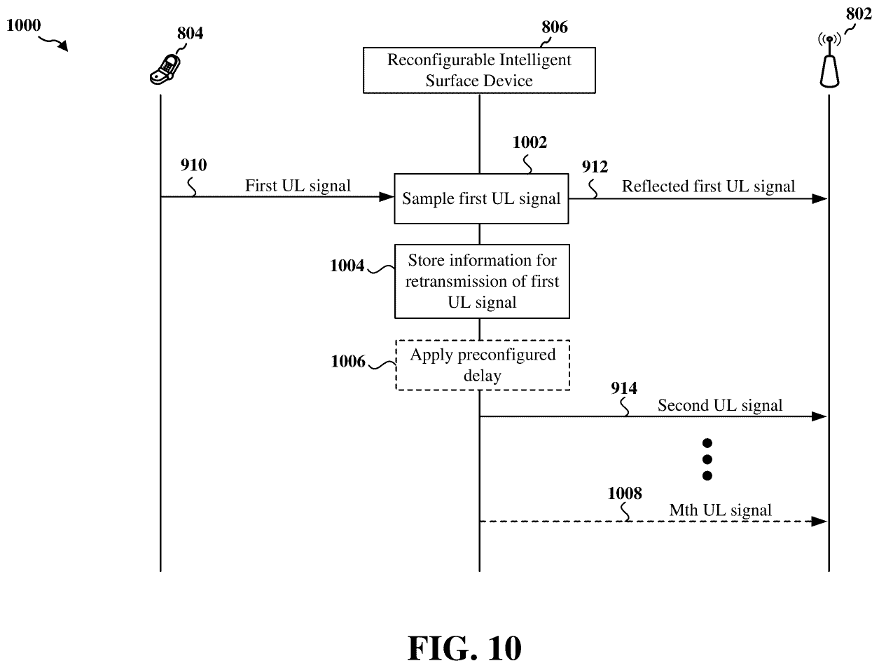

FIG. 10 illustrates a signal flow diagram 1000 in accordance with various aspects of the disclosure. The signal flow diagram 1000 includes the base station 802, the UE 804, and the RIS device 806. As shown in FIG. 10, the UE 804 may transmit the first uplink signal 910 toward the RIS device 806. The RIS device 806 may reflect the first uplink signal 910 toward the base station 802 as indicated in FIG. 10 with the reflected first uplink signal 912. The base station 802 may receive the reflected first uplink signal 912.

At 1002, the RIS device 806 may sample the first uplink signal 910 as previously described with reference to FIG. 8. For example, the RIS device 806 may obtain in-phase and quadrature signal information from the sampled first uplink signal 910.

At 1004, the RIS device 806 may store information for repetition (e.g., retransmission) of the first uplink signal 910. For example, the RIS device 806 may store the in-phase and quadrature signal information in the memory device 814.

At 1006, the RIS device 806 may optionally apply a preconfigured delay. For example, the preconfigured delay may be a period of time within a range of 5 to 50 microseconds (μs). In other examples, the period of time may be less than 5 μs or greater than 50 μs. In some aspects of the disclosure, the base station 802 may indicate the period of time to the RIS device 806.

In some examples, the RIS device 806 may transmit a number of repetitions (e.g., retransmissions) of the first uplink signal 910. For example, the RIS device 806 may transmit a second uplink signal 914 based on the in-phase and quadrature signal information of the first uplink signal 910 stored in the memory device 814. The second uplink signal 914 may be a retransmission of the first uplink signal 910. In some examples, the RIS device 806 may transmit up to an Mth uplink signal 1008, where each of the M uplink signals is a repetition of the first uplink signal 910.

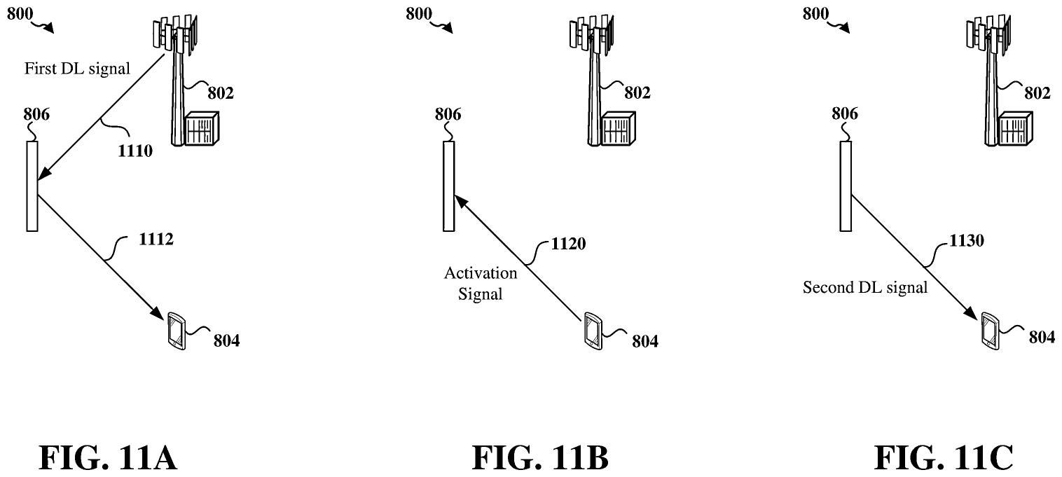

FIG. 11 (including FIGS. 11A, 11B, and 11C) illustrates repetition of a downlink signal transmission in the wireless communication network 800 in accordance with various aspects of the disclosure. In some scenarios, the base station 802 may transmit a downlink signal multiple times for successful reception and/or decoding at the UE 804. In the aspects described herein with reference to FIG. 11, repetitions (e.g., retransmissions) of a downlink signal transmission from the base station 802 may be delegated to the RIS device 806.

For example, as shown in FIG. 11A, the base station 802 may transmit a first downlink signal 1110 toward the RIS device 806. The first downlink signal 1110 may be an initial (e.g., original) transmission of a signal transmission or a repetition of the signal transmission. The RIS device 806 may be configured to reflect the first downlink signal 1110 toward the UE 804 as indicated in FIG. 11A with the reflected first downlink signal 1112. The RIS device 806 may be further configured to sample the first downlink signal 1110 and store in-phase and quadrature signal information for subsequent retransmission of the first downlink signal 1110.

The UE 804 may transmit an activation signal 1120 to the RIS device 806 based at least in part on the UE 804 being unable to decode the first downlink signal 1110. In some examples, the activation signal 1120 includes information that enables the RIS device 806 to identify the signal transmission to be repeated.

As shown in FIG. 11C, the RIS device 806 may transmit a second downlink signal 1130 toward the UE 804 in response to the activation signal 1120. The second downlink signal 1130 may be a repetition (e.g., retransmission) of the first downlink signal 1110 based on the previously stored in-phase and quadrature signal information of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804. Accordingly, while the reflected first downlink signal 1112 is a signal that was originally transmitted from BS 802 and reflected by surface 810 (e.g., without or independent of being received by reception antenna 818), the second downlink signal 1130 is originally transmitted from RIS device 806 via transmission antenna 820 based on sampling, storing, and/or processing a previously received signal from BS 802 via reception antenna 818.

Accordingly, the UE 804 transmitting the activation signal 1120 to the RIS device 806 based on the UE 804 being unable to decode the first downlink signal 110, instead of the UE 804 transmitting a NACK to the BS 802, may keep resources for the base station 802 available that would otherwise be used to retransmit the first downlink signal 110 and may further simplify scheduling at base station 802.

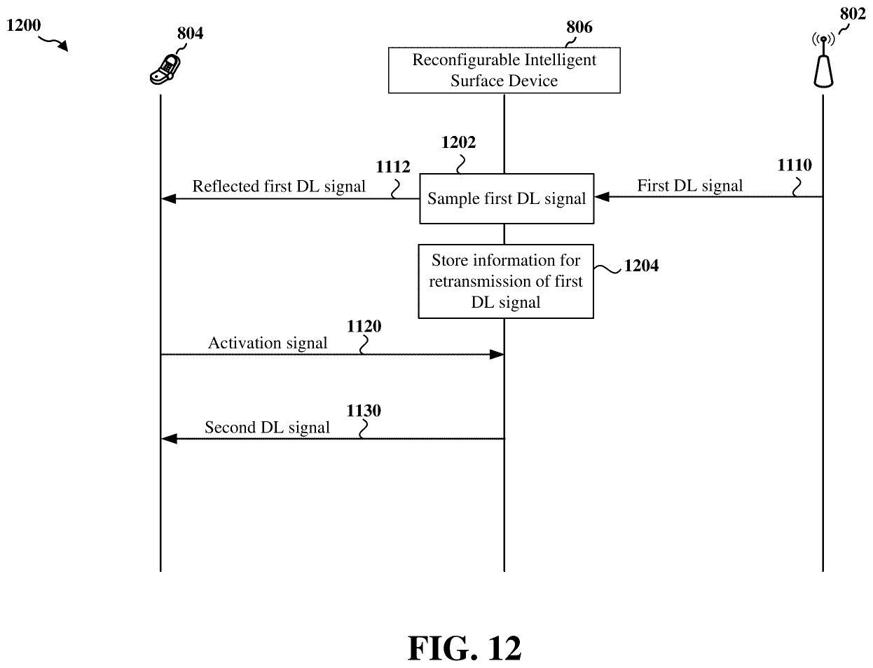

FIG. 12 is a signal flow diagram 1200 in accordance with various aspects of the present disclosure. FIG. 12 includes the base station 802, the UE 804, and the RIS device 806.

As shown in FIG. 12, the base station 802 may transmit a first downlink signal 1110 toward the RIS device 806. The RIS device 806 may be configured to reflect the first downlink signal 1110 toward the UE 804 as indicated in FIG. 12 with the reflected first downlink signal 1112. At 1202, the RIS device 806 may be further configured to sample the first downlink signal 1110 and store in-phase and quadrature signal information for subsequent retransmission of the first downlink signal 1110.

At 1204, the RIS device 806 may store information for repetition (e.g., retransmission) of the first downlink signal 1110. For example, the RIS device 806 may store the in-phase and quadrature signal information in the memory device 814.

The UE 804 may transmit an activation signal 1120 to the RIS device 806 when the UE 804 is unable to decode the first downlink signal 1110. In some examples, the activation signal 1120 includes information that enables the RIS device 806 to identify the signal transmission to be repeated.

The RIS device 806 may transmit the second downlink signal 1130 toward the UE 804 in response to the activation signal 1120. The second downlink signal 1130 may be a repetition (e.g., retransmission) of the first downlink signal 1110 based on the previously stored in-phase and quadrature signal information of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804.

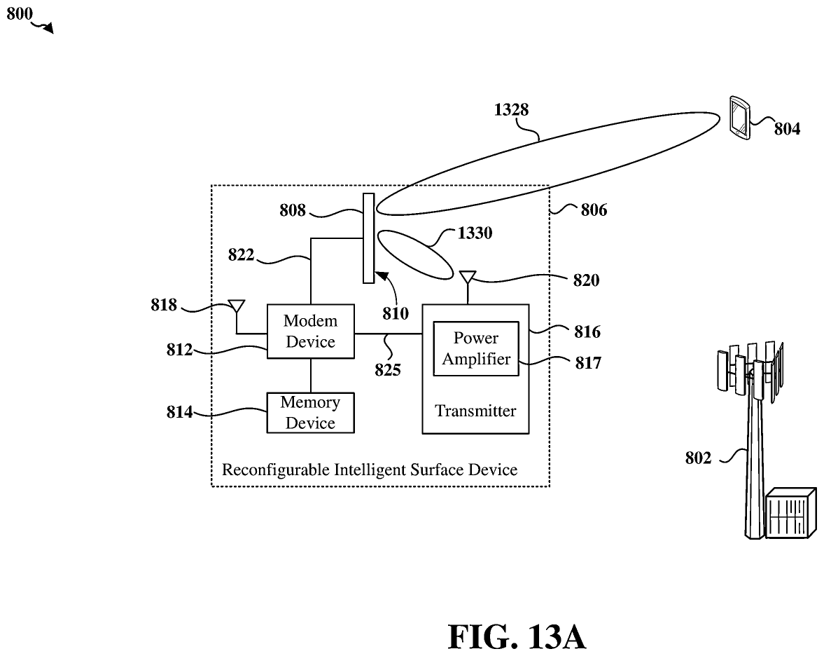

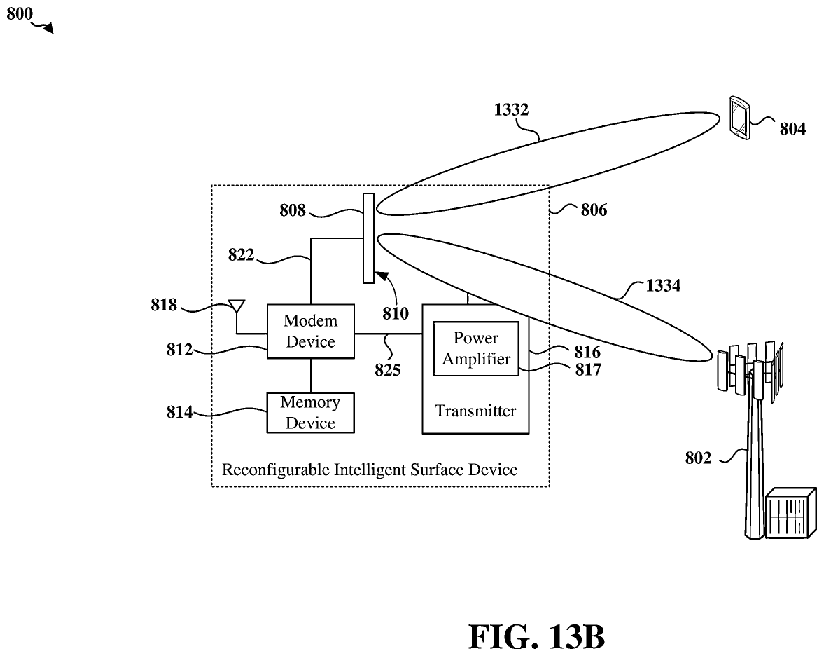

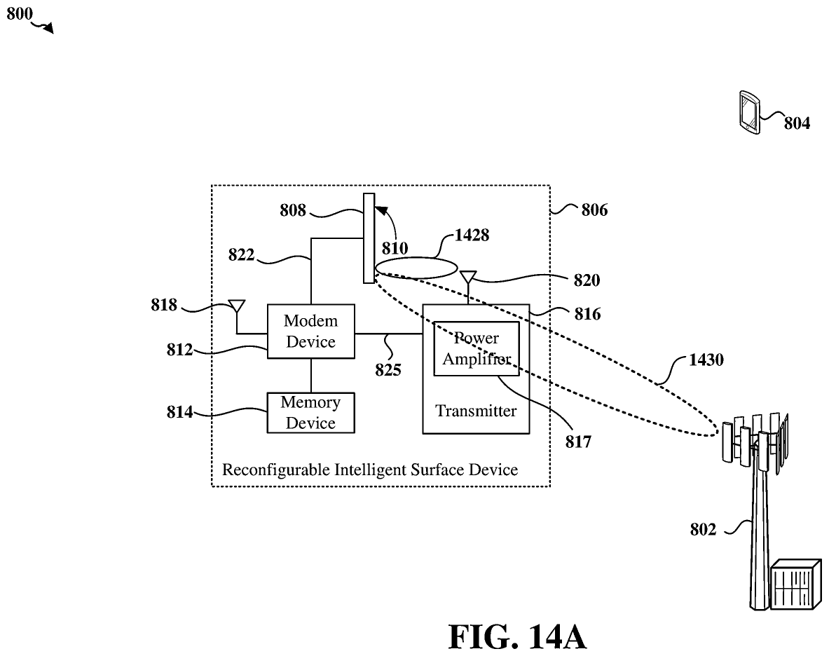

FIG. 13A is a diagram illustrating the wireless communication network 800 including the base station 802, the UE 804, and the RIS device 806 in accordance with various aspects of the disclosure. In some examples, the transmitter 816 of the RIS device 806 may transmit beamformed RF signals toward the surface 810 of the RIS 808. For example, the modem device 812 of the RIS device 806 may apply a near-field reflection configuration for the RIS 808 when the transmitter 816 transmits a beam (e.g., beam 1330) toward the surface 810 of the RIS 808. The near-field reflection configuration may reflect the beam 1330 toward the UE 804 via the beam 1328.

FIG. 13B is a diagram illustrating the wireless communication network 800 including the base station 802, the UE 804, and the RIS device 806 in accordance with various aspects of the disclosure. In some examples, the base station 802 may transmit beamformed RF signals toward the surface 810 of the RIS 808. For example, the modem device 812 of the RIS device 806 may apply a far-field reflection configuration for the RIS 808 when the base station 802 transmits a beam (e.g., beam 1334) toward the surface 810 of the RIS 808. The far-field reflection configuration may reflect the beam 1334 toward the UE 804 via the beam 1332.

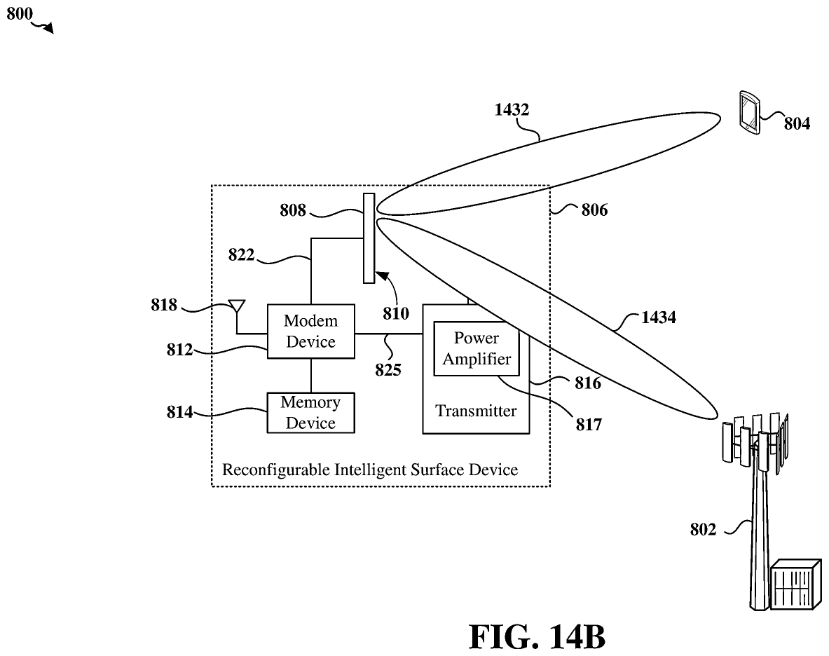

FIG. 14A is a diagram illustrating the wireless communication network 800 including the base station 802, the UE 804, and the RIS device 806 in accordance with various aspects of the disclosure. In some examples, the transmitter 816 of the RIS device 806 may transmit beamformed RF signals toward the surface 810 of the RIS 808. For example, the modem device 812 of the RIS device 806 may apply a near-field reflection configuration for the RIS 808 when the transmitter 816 transmits a beam (e.g., beam 1428) toward the surface 810 of the RIS 808. The near-field reflection configuration may reflect the beam 1428 toward the base station 802 via the beam 1430.

FIG. 14B is a diagram illustrating the wireless communication network 800 including the base station 802, the UE 804, and the RIS device 806 in accordance with various aspects of the disclosure. In some examples, the UE 804 may transmit beamformed RF signals toward the surface 810 of the RIS 808. For example, the modem device 812 of the RIS device 806 may apply a far-field reflection configuration for the RIS 808 when the UE 804 transmits a beam (e.g., beam 1432) toward the surface 810 of the RIS 808. The far-field reflection configuration may reflect the beam 1432 toward the base station 802 via the beam 1434.

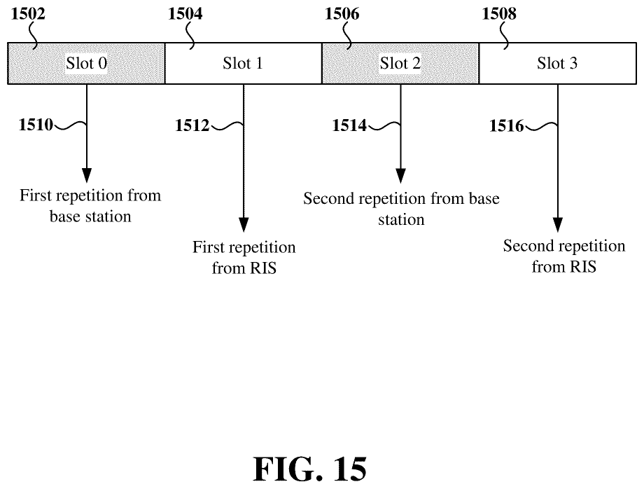

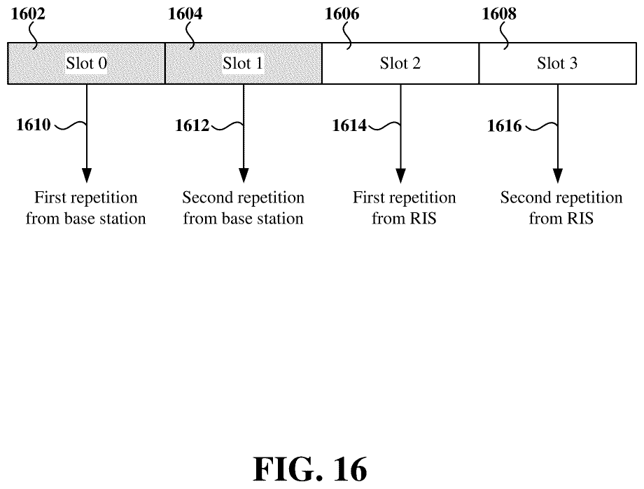

In some aspects of the disclosure, a base station may schedule a UE with N repetitions of a signal transmission according to a repetition pattern, where each of the N repetitions of the signal transmission may be transmitted from the base station. The reconfigurable intelligent surface (RIS) device described herein (e.g., the RIS device 806) may be configured to transmit a number of repetitions of the signal transmission for each of the N repetitions of the signal transmission. These aspects are described in detail with reference to FIGS. 15 and 16.

FIG. 15 is a diagram illustrating a number of contiguous slots in accordance with various aspects of the disclosure. For example, FIG. 15 includes a first slot 1502, a second slot 1504, a third slot 1506, and a fourth slot 1508. In the examples described with reference to FIG. 15, each of the slots 1502, 1504, 1506, 1508 may include a repetition of a signal transmission from the base station 802 or from the RIS device 806.

In some aspects of the disclosure, the base station 802 may provide control information to the UE 804 including a number N indicating the number of repetitions of the signal transmission from the base station 802, and a number M that indicates, or enables the UE 804 to determine, a number of additional repetitions of the signal transmission that may be transmitted from the RIS device 806 for each of the N repetitions of the signal transmission. In some aspects, the N repetitions may include an original or initial transmission of the signal transmission. The number M may further enable the UE 804 to determine the total number of repetitions of the signal transmission. For example, N may represent a first positive integer, and M may represent a second positive integer.

In one example, for each of the N repetitions of the signal transmission from the base station 802, the UE 804 may expect M−1 repetitions of the signal transmission from the RIS device 806. In some examples, the UE 804 may determine the total number of repetitions of the signal transmission to be transmitted to the UE 804 by determining the result of the expression N×M. Alternatively, for each of the N repetitions of the signal transmission from the base station 802, the UE 804 may expect M repetitions of the signal transmission from the RIS device 806.

In some aspects of the disclosure, the control information may further include a repetition pattern indication associated with the repetitions of the signal transmission from the base station 802 and the repetitions of the signal transmission from the reconfigurable intelligent surface device 806. In some examples, and as shown in FIG. 15, the repetition pattern indication may indicate an interleaved repetition pattern where the repetitions of the signal transmission from the base station 802 are interleaved with the repetitions of the signal transmission from the reconfigurable intelligent surface device 806. In other examples, and as shown in FIG. 16, the repetition pattern indication may indicate a consecutive repetition pattern where the repetitions of the signal transmission from the base station 802 are scheduled in a first consecutive order, and the repetitions of the signal transmission from the reconfigurable intelligent surface device 806 are scheduled in a second consecutive order.

In one example scenario, with reference to FIG. 15, the base station 802 may schedule the UE 804 with two repetitions of a signal transmission (e.g., N=2) according to an interleaved repetition pattern, where the two repetitions of the signal transmission from the base station 802 are interleaved with repetitions of the signal transmission from the RIS device 806. As shown in FIG. 15, for example, the base station may schedule the UE 804 to receive a first repetition 1510 (which may be an initial or original transmission) of the signal transmission from the base station 802 in the first slot 1502 and to receive a second repetition 1514 of the signal transmission from the base station 802 in the third slot 1506.

For example, the base station 802 may provide control information indicating that the N repetitions of the signal transmission from the base station 802 includes two repetitions (e.g., N=2), and that the number M that enables the UE 804 to determine a number of repetitions of the signal transmission from the RIS device 806 for each of the N repetitions of the signal transmission is two (e.g., M=2). In this example, since N=2 and M=2, the UE 804 may determine that four repetitions of the signal transmission can be expected by applying the expression M×N (e.g., 2×2=4 repetitions), such as the four repetitions 1510, 1512, 1514, 1516 over the four slots 1502, 1504, 1506, 1508.

With reference to FIG. 15, for example, since the UE is informed that M=2, the UE may apply the expression M−1 to determine that each of the N repetitions of the signal transmissions transmitted from the base station 802 may be followed by one repetition (e.g., 2−1=1 repetition) of the signal transmission from the RIS device 806. Accordingly, the UE 804 may expect to receive a first repetition 1512 of the signal transmission from the RIS device 806 in the second slot 1504 and may expect to receive a second repetition 1516 of the signal transmission from the RIS device 806 in the fourth slot 1508.

In another example scenario, with reference to FIG. 16, the base station may schedule the UE 804 with two repetitions of a signal transmission (e.g., N=2) according to a consecutive repetition pattern. In this example scenario, the two repetitions of the signal transmission from the base station may be scheduled in a first consecutive sequence, and the repetitions of the signal transmission from the RIS device 806 may be scheduled in a second consecutive sequence.

As shown in FIG. 16, for example, the base station 802 may schedule the UE 804 to receive a first repetition 1610 of a signal transmission from the base station in the first slot 1602 and to receive a second repetition 1612 of the signal transmission from the base station in the second slot 1604. As further shown in FIG. 16, the base station 802 may schedule the UE 804 to receive a first repetition 1614 of the signal transmission from the RIS device 806 in the third slot 1606 and to receive a second repetition 1616 of the signal transmission from the RIS device 806 in the fourth slot 1608.

For example, the base station 802 may provide control information indicating that the N repetitions of the signal transmission from the base station includes two repetitions (e.g., N=2), and that the number M that enables the UE 804 to determine a number of repetitions of the signal transmission from the RIS device 806 for each of the N repetitions of the signal transmission is two (e.g., M=2). In this example, since N=2 and M=2, the UE 804 may determine that four repetitions of the signal transmission can be expected by applying the expression M×N (e.g., 2×2=4 repetitions), such as the four repetitions 1610, 1612, 1614, 1616 over the four slots 1602, 1604, 1606, 1608.

With reference to FIG. 16, for example, since the UE 804 is informed that M=2, the UE 804 may apply the expression M−1 to determine that each of the N repetitions of the signal transmissions transmitted from the base station 802 may be followed by one repetition (e.g., 2−1=1 repetition) of the signal transmission from the RIS device 806. Accordingly, the UE 804 may expect to receive a first repetition 1614 of the signal transmission from the RIS device 806 in the third slot 1606 and may expect to receive a second repetition 1616 of the signal transmission from the RIS device 806 in the fourth slot 1608.

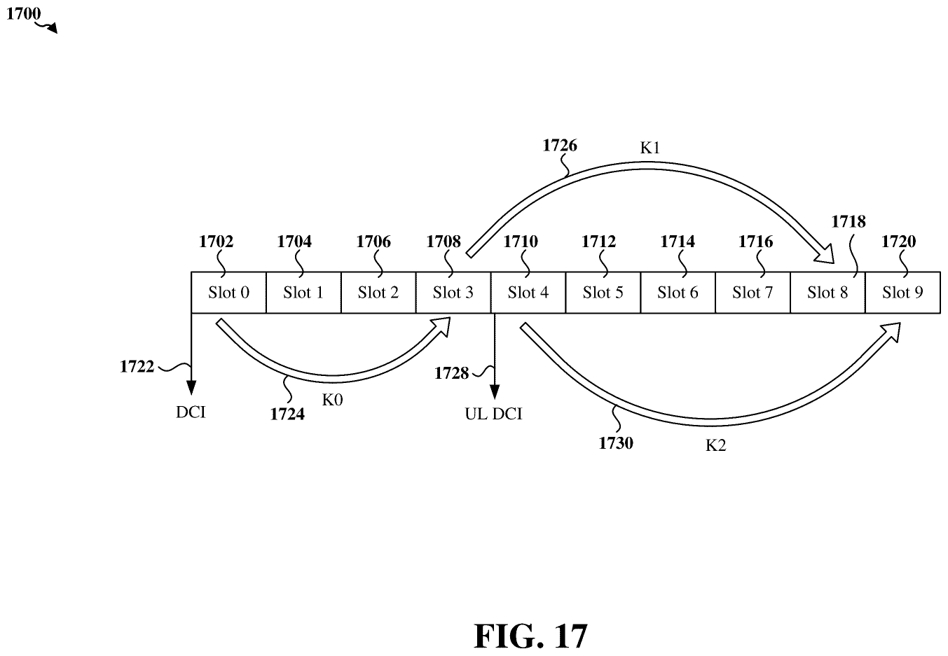

FIG. 17 illustrates a sequence of slots 1700 indicating an example application of network configured time gaps at a UE (e.g., the UE 804). As shown in FIG. 17, the sequence of slots 1700 includes a first slot (e.g., slot 0) 1702, a second slot (e.g., slot 1) 1704, a third slot (e.g., slot 2) 1706, and so on. Finally, the sequence of slots 1700 includes a tenth slot (slot 9) 1720.

In some aspects of the disclosure, the UE 804 may receive scheduling information indicating a first time gap 1724 between a last repetition of the signal transmission from the base station 802 in a downlink control channel (e.g., PDCCH) and an availability of a downlink data channel (e.g., PDSCH). For example, the first time gap 1724 may be referred to as a K0 offset and may represent a number of slots. In FIG. 17 for example, the UE 804 may receive DCI 1722 in the first slot 1702, where the DCI 1722 includes a K0 offset of 3 slots. The UE 804 may apply the K0 offset of 3 slots to determine that the downlink data channel begins in the fourth slot 1708.

In other aspects of the disclosure, the first time gap 1724 (e.g., the K0 offset) may be between a last repetition of the signal transmission from the RIS device 806 in a downlink control channel (e.g., PDCCH) and an availability of a downlink data channel (e.g., PDSCH). For example, the first time gap 1724 (e.g., the K0 offset) may be between a slot in which the last repetition of the signal transmission is received from the RIS device 806 in a downlink control channel (e.g., PDCCH) and a slot in which a downlink data channel (e.g., PDSCH) becomes available.

In some aspects of the disclosure, the UE 804 may determine to apply the first time gap 1724 (e.g., the K0 offset) with respect to a last repetition of the signal transmission from the base station 802 in a downlink control channel (e.g., PDCCH) or a last repetition of the signal transmission from the RIS device 806 in a downlink control channel (e.g., PDCCH) based on an indication in the scheduling information, based on the values of N, M, and the repetition pattern indication, and/or based on preconfigured information at the UE 804.

In some aspects of the disclosure, the UE 804 may receive scheduling information indicating a second time gap 1726 between a last repetition of the signal transmission from the base station 802 in a downlink data channel (e.g., PDSCH) and an availability of an uplink control channel (e.g., PUCCH). For example, the second time gap 1726 may be referred to as a K1 offset and may represent a number of slots. In FIG. 17 for example, the UE 804 may receive a K1 offset of 5 slots in the fourth slot 1708. The UE may apply the K1 offset of 5 slots to determine that the uplink control channel begins in the ninth slot 1718.

In other aspects of the disclosure, the second time gap 1726 (e.g., the K1 offset) may be between a last repetition of the signal transmission from the RIS device 806 in a downlink data channel (e.g., PDSCH) and an availability of an uplink control channel (e.g., PUCCH). For example, the second time gap 1726 (e.g., the K1 offset) may be between a slot in which the last repetition of the signal transmission is received from the RIS device 806 in a downlink data channel (e.g., PDSCH) and a slot in which an uplink control channel (e.g., PUCCH) becomes available.

In some aspects of the disclosure, the UE 804 may determine to apply the second time gap 1726 (e.g., the K1 offset) with respect to a last repetition of the signal transmission from the base station 802 in a downlink data channel (e.g., PDSCH) or a last repetition of the signal transmission from the RIS device 806 in a downlink data channel (e.g., PDSCH) based on an indication in the scheduling information, based on the values of N, M, and the repetition pattern indication, and/or based on preconfigured information at the UE 804.

In some aspects of the disclosure, the UE 804 may receive scheduling information indicating a third time gap 1730 between a last repetition of the signal transmission from the base station 802 in a downlink control channel (e.g., PDCCH) and an availability of an uplink data channel (e.g., PUSCH). For example, the third time gap 1730 may be referred to as a K2 offset and may represent a number of slots. In FIG. 17 for example, the UE may receive UL DCI 1728 in the fifth slot 1710, where the UL DCI 1728 includes a K2 offset of 5 slots. The UE 804 may apply the K2 offset of 5 slots to determine that the uplink data channel begins in the tenth slot 1720.

In other aspects of the disclosure, the third time gap 1730 (e.g., the K2 offset) may be between a last repetition of the signal transmission from the RIS device 806 in a downlink control channel (e.g., PDCCH) and an availability of an uplink data channel (e.g., PUSCH). For example, the third time gap 1730 (e.g., the K2 offset) may be between a slot in which the last repetition of the signal transmission is received from the RIS device 806 in a downlink control channel (e.g., PDCCH) and a slot in which an uplink data channel (e.g., PUSCH) becomes available.

In some aspects of the disclosure, the UE 804 may determine to apply the third time gap 1730 (e.g., the K2 offset) with respect to a last repetition of the signal transmission from the base station 802 in a downlink control channel (e.g., PDCCH) or a last repetition of the signal transmission from the RIS device 806 in a downlink control channel (e.g., PDCCH) based on an indication in the scheduling information, based on the values of N, M, and the repetition pattern indication, and/or based on preconfigured information at the UE 804.

Therefore, in some aspects of the disclosure, the UE receives scheduling information indicating at least one of a first time gap (e.g., the K0 offset) between a last repetition of the signal transmission transmitted from the reconfigurable intelligent surface device in a downlink control channel and an availability of a downlink data channel, a second time gap (e.g., the K1 offset) between a last repetition of the signal transmission transmitted from the reconfigurable intelligent surface device in a downlink data channel and an availability of an uplink control channel, or a third time gap (e.g., the K2 offset) between a last repetition of the signal transmission transmitted from the reconfigurable intelligent surface device in a downlink control channel and an availability of an uplink data channel.

In other aspects of the disclosure, the UE 804 may receive scheduling information indicating at least one of: a first time gap (e.g., the K0 offset) between a last repetition of the signal transmission from the base station 802 in a downlink control channel (e.g., PDCCH) and an availability of a downlink data channel (e.g., PDSCH), a second time gap (e.g., the K1 offset) between a last repetition of the signal transmission from the base station 802 in a downlink data channel (e.g., PDSCH) and an availability of an uplink control channel (e.g., PUCCH), or a third time gap (e.g., the K2 offset) between a last repetition of the signal transmission from the base station 802 in a downlink control channel (e.g., PDCCH) and an availability of an uplink data channel (e.g., PUSCH).

The UE 804 may communicate with the base station 802 based on the scheduling information. For example, the UE 804 may receive a downlink signal transmission from the base station when a downlink channel (e.g., PDCCH/PDSCH) is available or may transmit an uplink signal (e.g., a ACK signal) to the base station when an uplink channel (e.g., PUCCH/PUSCH) is available.

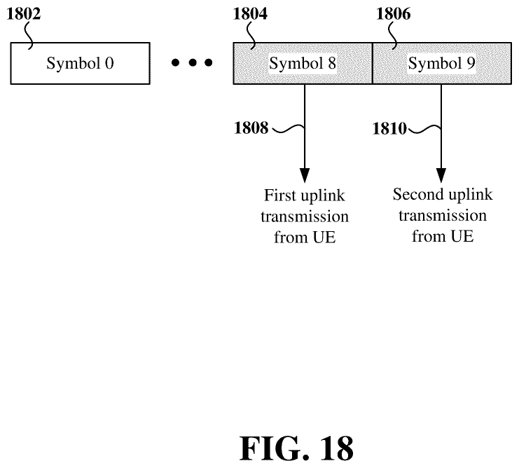

A UE (e.g., the UE 804) may transmit uplink transmissions in consecutive symbols. For example, FIG. 18 is a diagram illustrating a sequence of symbols including a first symbol 1802 (also referred to as symbol 0), a ninth symbol 1804 (also referred to as symbol 8), and a tenth symbol 1806 (also referred to as symbol 9). In one example scenario, the UE 804 may be configured to transmit a first uplink transmission in the ninth symbol 1804 and a second uplink transmission in the tenth symbol 1806. For example, the first and second uplink transmissions may include uplink control information (UCI) and may be transmitted in an uplink control channel, such as PUCCH in accordance with PUCCH format 0.

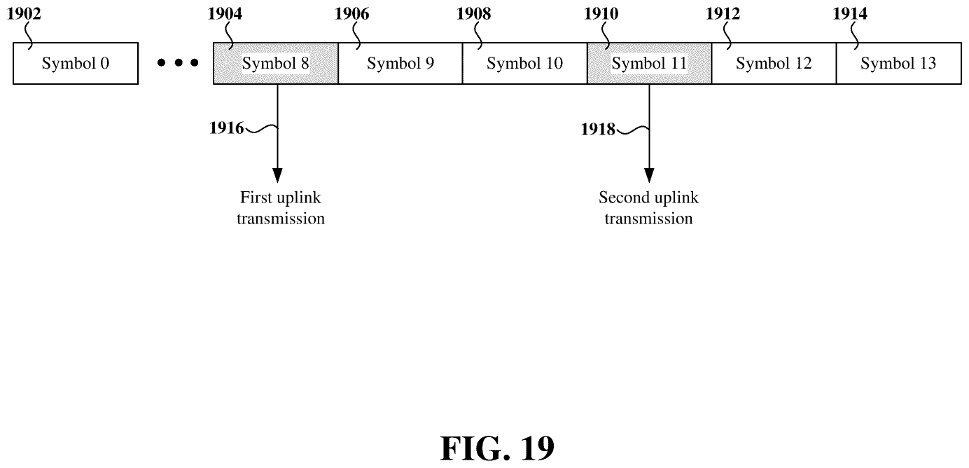

In some aspects of the disclosure, the UE 804 may receive scheduling information for a first uplink transmission in a first time period and a second uplink transmission in a second time period. If the RIS device 806 is configured to repeat the first uplink transmission and/or the second uplink transmission, the UE 804 may delay the second uplink transmission and/or any additional uplink transmissions following the second uplink transmission to allow time for the repetitions from the RIS device 806. These aspects are described in detail with reference to FIG. 19.

FIG. 19 is a diagram illustrating a sequence of symbols including a first symbol 1902 (also referred to as symbol 0), a ninth symbol 1904 (also referred to as symbol 8), a tenth symbol 1906 (also referred to as symbol 9), an eleventh symbol 1908 (also referred to as symbol 10), a twelfth symbol 1910 (also referred to as symbol 11), a thirteenth symbol 1912 (also referred to as symbol 12), and a fourteenth symbol 1914 (also referred to as symbol 13). In one example scenario, the UE 804 may be configured to transmit uplink transmissions in consecutive symbols, such as a first uplink transmission in the ninth symbol 1904 and a second uplink transmission in the tenth symbol 1906. For example, the first and second uplink transmissions may include uplink control information (UCI) and may be configured for transmission in an uplink control channel, such as PUCCH in accordance with PUCCH format 0.

The UE 804 may further receive control information indicating a number of repetitions of the first uplink transmission and the second uplink transmission, where the repetitions of the first uplink transmission and the second uplink transmission are to be transmitted from the reconfigurable intelligent surface device (RIS) 806. For example, the control information may indicate that the RIS device 806 is to transmit two repetitions of the first uplink transmission and two repetitions of the second uplink transmission.

In some aspects, the control information may further include a repetition pattern indication. In other aspects of the disclosure, the UE 804 may be preconfigured with the repetition pattern. In these aspects, the control information may not include a repetition pattern indication. For example, the repetition pattern indication may indicate an interleaved repetition pattern where the repetitions of the first uplink transmission and the second uplink transmission from the RIS device 806 are interleaved with the first and second uplink transmissions from the UE 804.

As shown in FIG. 19, the UE 804 may transmit the first uplink transmission 1916 in the ninth symbol 1904 and may delay the second uplink transmission 1918 based at least in part on the number of repetitions of the first uplink transmission 1916. For example, if the control information indicates that the RIS device 806 is to transmit two repetitions of the first uplink transmission 1916, the UE 804 may transmit the second uplink transmission 1918 in the twelfth symbol 1910 instead of the tenth symbol 1906 to allow time for the two repetitions of the first uplink transmission 1916 in the tenth and eleventh symbols 1906, 1908. In some examples, the UE 804 may transmit any uplink transmissions (e.g., a third uplink transmission) subsequent to the second uplink transmission 1918 after the fourteenth symbol 1914 to allow time for the two repetitions of the second uplink transmission 1918 in the thirteenth and fourteenth symbols 1912, 1914.

In the examples described with reference to FIG. 19, a UE (e.g., the UE 804) may receive the control information from the RIS device 806 and/or a base station (e.g., the base station 802). In some examples, all or a portion of the control information may be preconfigured at the UE 804.

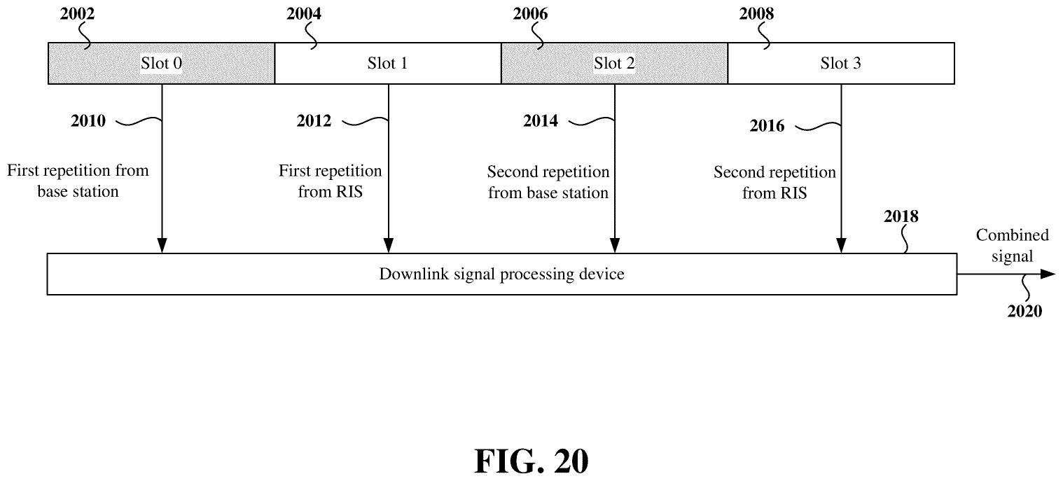

In some aspects of the disclosure, the UE 804 may process a first number of repetitions of a signal transmission from the base station 802 and a second number of repetitions of the signal transmission from the RIS device 806 based on the quasi-colocation (QCL) information associated with the first number of repetitions of the signal transmission from the base station 802 and the quasi-colocation (QCL) information associated with the second number of repetitions of the signal transmission from the RIS device 806. This is described in detail with reference to FIG. 20.

FIG. 20 is a diagram illustrating a number of contiguous slots in accordance with various aspects of the disclosure. For example, FIG. 20 includes a first slot 2002, a second slot 2004, a third slot 2006, and a fourth slot 2008. In the examples described with reference to FIG. 20, each of the slots 2002, 2004, 2006, 2008 may include a repetition of a signal transmission from the base station 802 or from the RIS device 806.

In some aspects of the disclosure, the base station 802 may provide control information to the UE 804 including a number N indicating the number of repetitions of the signal transmission from the base station, and a number M that enables the UE to determine a number of additional repetitions of the signal transmission that may be transmitted from the RIS device 806 for each of the N repetitions of the signal transmission as previously described with reference to FIG. 15. In some aspects of the disclosure, the control information may further include a repetition pattern indication associated with the repetitions of the signal transmission from the base station 802 and the repetitions of the signal transmission from the reconfigurable intelligent surface device 806. For example, as previously described with reference to FIG. 15, the repetition pattern indication may indicate an interleaved repetition pattern or a consecutive repetition pattern.

In one example scenario, with reference to FIG. 20, the base station may schedule the UE 804 with two repetitions of a signal transmission (e.g., N=2) according to an interleaved repetition pattern, where the two repetitions of the signal transmission from the base station 802 are interleaved with repetitions of the signal transmission from the RIS device 806. As shown in FIG. 20, for example, the base station 802 may schedule the UE 804 to receive a first repetition 2010 of the signal transmission from the base station 802 in the first slot 2002 and to receive a second repetition 2014 of the signal transmission from the base station 802 in the third slot 2006.

With reference to FIG. 20, for example, the UE 804 may be informed that M=2 and may apply the expression M−1 to determine that each of the N repetitions of the signal transmissions transmitted from the base station may be followed by one repetition (e.g., 2−1=1 repetition) of the signal transmission from the RIS device 806. Accordingly, the UE 804 may expect to receive a first repetition 2012 of the signal transmission from the RIS device 806 in the second slot 2004 and may expect to receive a second repetition 2016 of the signal transmission from the RIS device 806 in the fourth slot 2008.

In some aspects of the disclosure, the UE 804 may determine whether the first and second repetitions 2010, 2014 of the signal transmission from the base station 802 and the first and second repetitions 2012, 2016 of the signal transmission from the RIS device 806 are quasi co-located (QCLed) with different downlink reference signals or a same downlink reference signal. In some examples, the UE 804 may determine that different downlink reference signals are used for QCL if the first and second repetitions 2010, 2014 of the signal transmission from the base station are QCLed with a reference signal (e.g., CSI-RS) transmitted from the base station 802, and the first and second repetitions 2012, 2016 of the signal transmission from the RIS device 806 are QCLed with a reference signal (e.g., CSI-RS) transmitted from the RIS device 806. In other examples, the UE 804 may determine that the same downlink reference signal is used for QCL if the first and second repetitions 2010, 2014 of the signal transmission from the base station 802 and the first and second repetitions 2012, 2016 of the signal transmission from the RIS device 806 are QCLed with a reference signal (e.g., CSI-RS) transmitted from the base station 802.

The downlink signal processing device 2018 of the UE 804 may process the first and second repetitions 2010, 2014 of the signal transmission and the first and second repetitions 2012, 2016 of the signal transmission by combining the first and second repetitions 2010, 2014 of the signal transmission and the first and second repetitions 2012, 2016 of the signal transmission based on the appropriate reference signals used for QCL to provide a combined signal 2020.

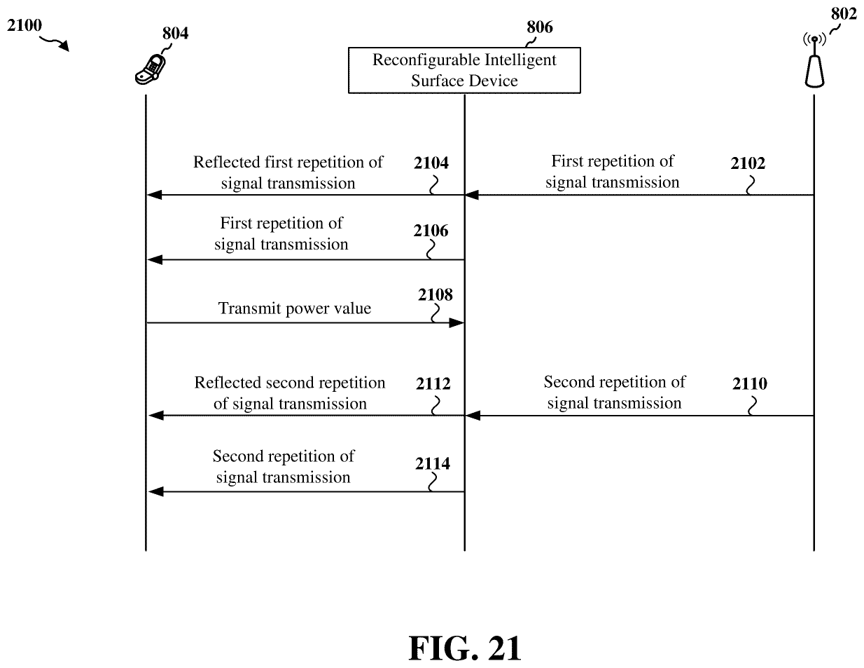

FIG. 21 illustrates a signal flow diagram 2100 in accordance with various aspects of the disclosure. The signal flow diagram 2100 includes the base station 802, the UE 804, and the RIS device 806. The base station 802 may transmit a first repetition of a signal transmission 2102 in the direction of the RIS device 806. The RIS device 806 may reflect the first repetition of the signal transmission 2102 from the base station 802 toward the UE 804 (e.g., shown in FIG. 21 as the reflected first repetition of the signal transmission 2104). The RIS device 806 may subsequently transmit a downlink signal 2106 that includes the first repetition of the signal transmission toward the UE 804.

In some scenarios, the UE 804 may determine that the receive power of the reflected first repetition of the signal transmission 2104 is different from the receive power of the downlink signal 2106 that includes the first repetition of the signal transmission. In these scenarios, the UE 804 may transmit a transmit power value 2108 to the RIS device 806. In some examples, the transmit power value 2108 from the UE 804 may enable downlink signals from the RIS device 806 and reflected repetitions of a signal transmission from the base station 802 to be received at the UE 804 with approximately the same receive power (e.g., approximately the same reference signal received power (RSRP) measurement). In the aspects described herein, the phrase “approximately the same” means equal or within a range of ±5%. For example, the RIS deice 806 may adjust the transmission power of the transmitter 816 (e.g., by changing settings of power amplifier 817) and/or a configuration of RIS 808 based on the transmit power value 2108.

The base station 802 may further transmit a second repetition of the signal transmission 2110 in the direction of the RIS device 806. The RIS device 806 may reflect the second repetition of the signal transmission 2110 from the base station 802 toward the UE 804 (e.g., shown in FIG. 21 as the reflected second repetition of the signal transmission 2112). The RIS device 806 may subsequently transmit a downlink signal 2114 that includes the second repetition of the signal transmission toward the UE 804. In some examples, the RIS device 806 may transmit the downlink signal 2114 based on the transmit power value 2108. In these examples, the downlink signal 2114 may be received at the UE 804 with approximately the same receive power as the reflected second repetition of the signal transmission 2112.

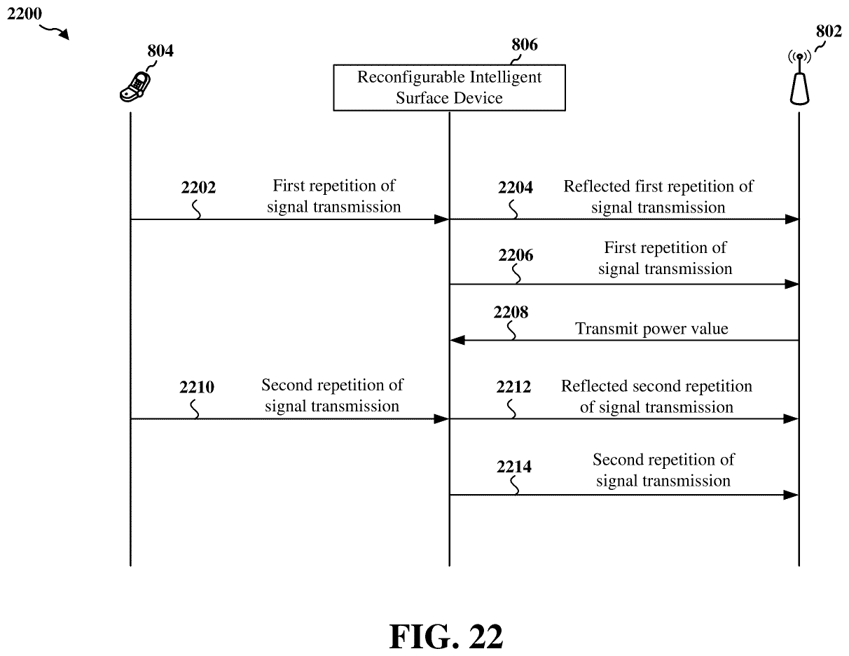

FIG. 22 illustrates a signal flow diagram 2200 in accordance with various aspects of the disclosure. The signal flow diagram 2200 includes the base station 802, the UE 804, and the RIS device 806. The UE 804 may transmit a first repetition of a signal transmission 2202 in the direction of the RIS device 806. The RIS device 806 may reflect the first repetition of the signal transmission 2202 from the UE 804 toward the base station 802 (e.g., shown in FIG. 22 as the reflected first repetition of the signal transmission 2204). The RIS device 806 may subsequently transmit an uplink signal 2206 that includes the first repetition of the signal transmission toward the base station 802.

In some scenarios, the base station 802 may determine that the receive power of the reflected first repetition of the signal transmission 2204 is different from the receive power of the uplink signal 2206 that includes the first repetition of the signal transmission. In these scenarios, the base station 802 may transmit a transmit power value 2208 to the RIS device 806. In some examples, the transmit power value 2208 from the base station 802 may enable uplink signals from the RIS device 806 and reflected repetitions of a signal transmission from the UE 804 to be received at the base station 802 with approximately the same receive power (e.g., approximately the same reference signal received power (RSRP) measurement).

The UE 804 may further transmit a second repetition of the signal transmission 2210 in the direction of the RIS device 806. The RIS device 806 may reflect the second repetition of the signal transmission 2110 from the base station 802 toward the base station 802 (e.g., shown in FIG. 22 as the reflected second repetition of the signal transmission 2212). The RIS device 806 may subsequently transmit an uplink signal 2212 that includes the second repetition of the signal transmission toward the base station 802. In some examples, the RIS device 806 may transmit the uplink signal 2214 based on the transmit power value 2208. In these examples, the uplink signal 2214 may be received at the base station 802 with approximately the same receive power as the reflected second repetition of the signal transmission 2212.

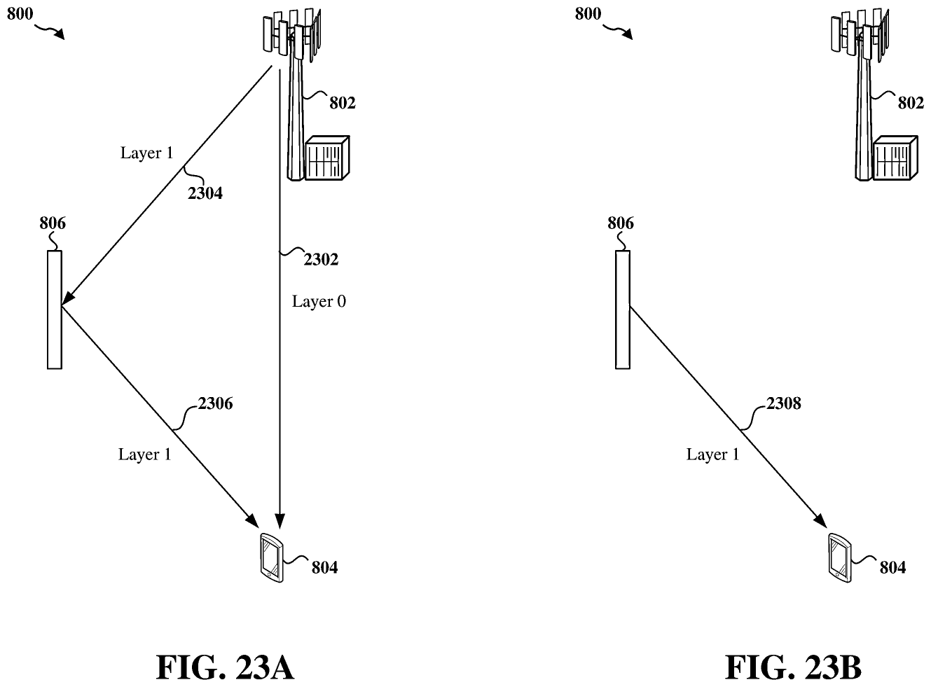

FIG. 23 (including FIGS. 23A and 23B) is a diagram illustrating example multiple-input and multiple-output (MIMO) transmissions in the wireless communication network 800 in accordance with various aspects of the disclosure. In some examples, the base station 802 may implement spatial multiplexing to transmit different information-carrying symbol streams to the UE 804. The base station 802 may generate a symbol stream by modulating data (e.g., encoded data) using a modulation scheme, such as binary phase-shift keying (BPSK), quadrature phase-shift keying (QPSK), M-phase-shift keying (M-PSK), M-quadrature amplitude modulation (M-QAM.

The symbol streams may be mapped to the same set of time-frequency resources and may have different spatial signatures (e.g., different precoding weights). Each of these symbol streams may be referred to as a layer and may be associated with a certain channel (e.g., a certain propagation path) in the wireless communication network 800. In the example of FIG. 23A, the first layer (e.g., layer 0) may be associated with a direct transmission (e.g., a line of sight transmission) of the first stream 2302 to the UE 804. The second layer (e.g., layer 1) may be associated with a transmission of the second stream 2304 directed toward the reconfigurable intelligent surface (RIS) 806. The reconfigurable intelligent surface (RIS) 806 may be configured to reflect the second stream 2304 toward the UE 804 as indicated with the reflected second stream 2306.

With reference to FIG. 23A, for example, the base station 802 may transmit a signal transmission to the UE 804 via multiple layers (e.g., two or more different layers). For example, the base station 802 may transmit a signal transmission to the UE 804 via the first layer (e.g., layer 0) and the second layer (e.g., layer 1). In one example, the reconfigurable intelligent surface (RIS) 806 may receive the signal transmission via the first layer (e.g., layer 1) and may store in-phase and quadrature signal information of the signal transmission. The RIS device 806 may repeat (e.g., retransmit) the signal transmission received via the first layer (e.g., layer 1) as illustrated with the retransmitted second stream 2308 shown in FIG. 23B.

In some aspects of the disclosure, the UE 804 may receive information identifying one or more layers of a multi-layer transmission, where the one or more layers are associated with repetitions of a signal transmission from the RIS device 806. Therefore, in some examples, the information identifying one or more layers of a multi-layer transmission may include at least partial precoding information (e.g., precoder matrix information) of the multi-layer transmission. In one example, the information may identify one or more layers that are directed toward the RIS device 806. This may enable the UE 804 to associate repetitions of a signal transmission from the RIS device 806 with the corresponding layer.

For example, with reference to FIG. 23A, the UE 804 may receive information indicating that the second layer (e.g., layer 1) is beamformed toward the RIS device 806. In some examples, the information may further indicate that the first layer (e.g., layer 0) is a direct transmission (e.g., a line of sight transmission). The UE 804 may process (e.g., demodulate and/or decode) repetitions of a signal transmission from the RIS device 806 (e.g., the retransmitted second stream 2308 shown in FIG. 23B) based on the information identifying the one or more layers that are directed toward the RIS device 806.

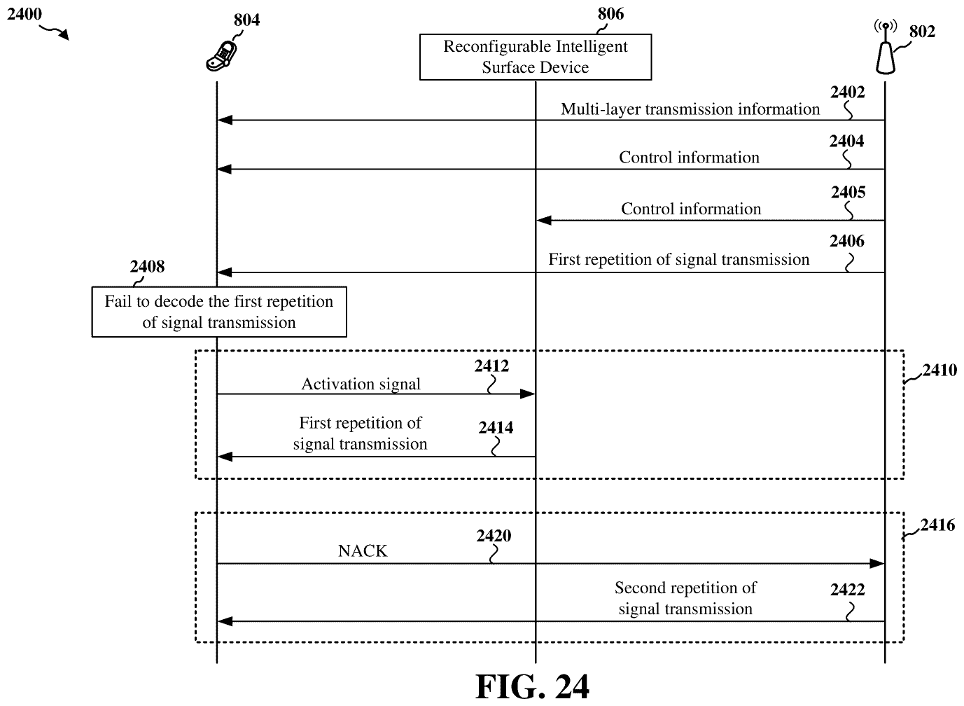

FIG. 24 illustrates a signal flow diagram 2400 in accordance with various aspects of the disclosure. FIG. 24 includes the base station 802, the UE 804, and the RIS device 806.

With reference to FIG. 24, the base station 802 may transmit multi-layer transmission information 2402 to the UE 804. The multi-layer transmission information 2402 may identify one or more layers of a multi-layer transmission (e.g., a massive MIMO transmission). For example, the multi-layer transmission information 2402 may indicate that a first layer (e.g., layer 0 in FIG. 23A) of a multi-layer transmission is a direct transmission (e.g., a line of sight transmission) to the UE 804 and that a second layer (e.g., layer 1 in FIG. 23A) of the multi-layer transmission is directed toward the RIS device 806.

The base station 802 may further transmit control information 2404 to the UE 804. The control information 2404 may indicate whether the UE 804 should transmit an activation signal to the RIS device 806 or a NACK signal to the base station 802 in scenarios where the UE 804 fails to decode a repetition of a signal transmission (e.g., the first repetition of a signal transmission 2406). In some examples, the control information 2404 may further include a first value (e.g., N) indicating the first number of repetitions of the signal transmission from the base station, and a second value (e.g., M−1) indicating the second number of repetitions of the signal transmission. In some examples, the control information 2404 may further include a repetition pattern indication associated with the first number of repetitions of the signal transmission from the base station and the second number of repetitions of the signal transmission.

The base station 802 may further transmit control information 2405 to the RIS device 806. In some examples, the control information 2405 may include at least some of the information included in the control information 2404. For example, the control information 2405 may include the first value (e.g., N) indicating the first number of repetitions of the signal transmission from the base station, and the second value (e.g., M−1) indicating the second number of repetitions of the signal transmission. For example, the control information 2405 may further include the repetition pattern indication associated with the first number of repetitions of the signal transmission from the base station and the second number of repetitions of the signal transmission. In other examples, the control information 2405 may be the same as the control information 2404.

In some examples, the base station 802 may transmit the first repetition of the signal transmission 2406 via two or more layers (e.g., layer 0 and layer 1 as described with reference to FIG. 23). For example, the first repetition of the signal transmission 2406 may be a data transmission in a data channel (e.g., PDSCH). The UE 804 may receive the first repetition of the signal transmission 2406 and, at 2408, the UE 804 may fail to decode the first repetition of the signal transmission 2406.

In some examples, if the first repetition of the signal transmission 2406 may be decoded with a reception of one of the two or more layers (e.g., layer 0 or layer 1), the control information 2404 may indicate to the UE 804 that the UE 804 should transmit an activation signal 2412. For example, the first repetition of the signal transmission 2406 may be decoded with a reception of one of the two or more layers if the same code blocks of the first repetition of the signal transmission 2406 are allocated to each of the two or more layers (e.g., layer 0 or layer 1).

The RIS device 806 may transmit the first repetition of the signal transmission 2414 to the UE 804 in response to the activation signal 2412. It should be noted that the RIS device 806 may transmit a subset of the two or more layers of the multi-layer transmission from the base station 802. Therefore, the RIS device 806 may retransmit layers that were previously received from the base station 802. For example, the first repetition of the signal transmission 2414 may not include layers associated with line of sight transmissions from the base station 802 to the UE 804 (e.g., layer 0 in FIG. 23). The first repetition of the signal transmission 2414 may be referred to as a partial retransmission of the first repetition of the signal transmission 2414. The UE 804 may decode the first repetition of the signal transmission 2414 received from the RIS device 806.

In other examples, if the first repetition of the signal transmission 2406 may not be decoded with a reception of one of the two or more layers (e.g., layer 0 or layer 1), the control information 2404 may indicate to the UE 804 that the UE 804 should transmit a negative acknowledgement (NACK) 2420. For example, the first repetition of the signal transmission 2406 may not be decoded with a reception of one of the two or more layers if different code blocks of the first repetition of the signal transmission 2406 are allocated to different layers. The base station 802 may transmit a second repetition of the signal transmission 2422 via two or more layers (e.g., layer 0 and layer 1 as described with reference to FIG. 23) in response to the NACK 2420. The UE 804 may receive the second repetition of the signal transmission 2422 via the two or more layers and may successfully decode the second repetition of the signal transmission 2422.

In the aspects described with reference to FIG. 24, it should be understood that the first and second sets of transmissions 2410, 2416 indicated with dotted lines may be optionally implemented based on the control information 2404. For example, if the first set of transmissions 2410 including the transmission of the activation signal 2412 from the UE 804 and the transmission of the first repetition of the signal transmission 2414 from the RIS device 806 are implemented, the second set of transmissions 2416 may not be implemented. In another example, if the second set of transmissions 2416 including the transmission of the NACK 2420 and the second repetition of the signal transmission 2422 from the base station 802 are implemented, the first set of transmissions 2410 may not be implemented.

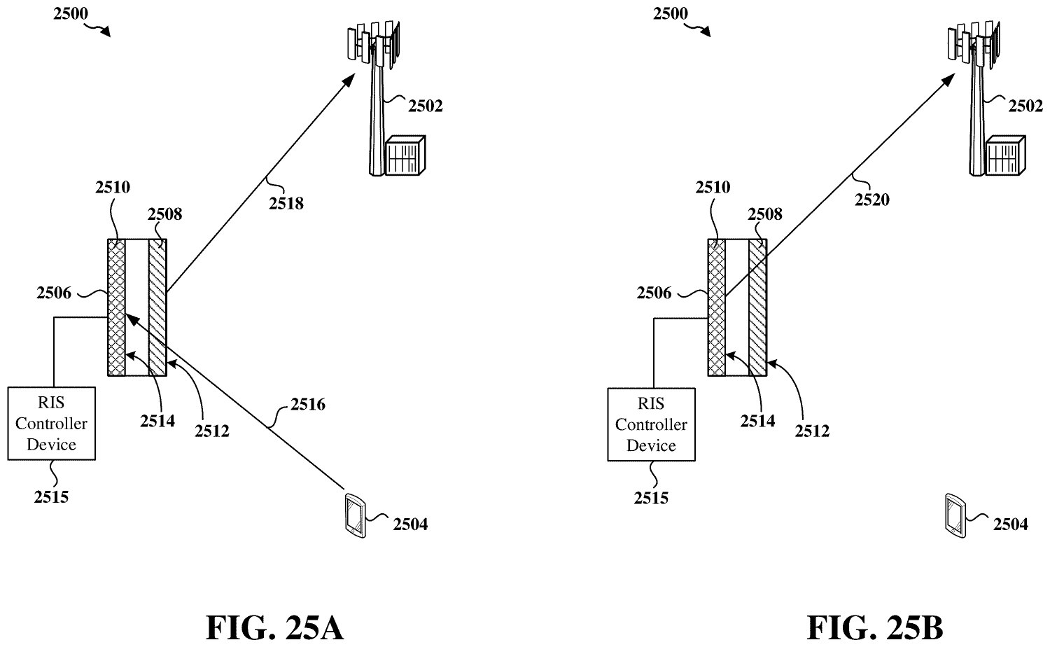

FIG. 25 (including FIGS. 25A and 25B) illustrates repetition of an uplink signal transmission in a wireless communication network 2500 in accordance with various aspects of the disclosure. The wireless communication network 2500 includes a base station 2502, a UE 2504, and a reconfigurable intelligent surface (RIS) device 2506.

In some examples, the reconfigurable intelligent surface (RIS) device 2506 may include a first reconfigurable reflective layer 2508 and a second reconfigurable reflective layer 2510. The first reconfigurable reflective layer 2508 may include a first grid of reflective elements, and the second reconfigurable reflective layer 2510 may include a second grid of reflective elements. The first grid of reflective elements may form a first surface 2512 and the second grid of reflective elements may form a second surface 2514. The first reconfigurable reflective layer 2508 and a second reconfigurable reflective layer 2510 may be considered to be co-located at the reconfigurable intelligent surface (RIS) device 2506.

Each of the reflective elements in the first grid of reflective elements and the second grid of reflective elements may be configured to reflect incident signals (e.g., beamformed radio frequency (RF) signals) in a desired direction. In some examples, the reflective elements in the first grid of reflective elements and the second grid of reflective elements may be electronically configured via a reconfigurable intelligent surface (RIS) controller device 2515.

In the aspects described with reference to FIG. 25, the first reconfigurable reflective layer 2508 may reflect an incident signal immediately (e.g., instantaneously), and the second reconfigurable reflective layer 2510 may reflect the incident signal after a preconfigured delay. For example, the preconfigured delay may be within a range of 10 μs to 50 μs. In some aspects of the disclosure, the preconfigured delay may be achieved through the physical characteristics of the second reconfigurable reflective layer 2510. In these aspects, the preconfigured delay may be achieved without the use of an antenna, modem device, and transmitter at the reconfigurable intelligent surface (RIS) device 2506.

In some scenarios, the UE 2504 may transmit an uplink signal multiple times for successful reception and/or decoding at the base station 2502. In the aspects described herein with reference to FIG. 25, repetitions of an uplink signal transmission from the UE 2504 may be delegated to the reconfigurable intelligent surface (RIS) device 2506.

For example, as shown in FIG. 25A, the UE 2504 may transmit a first uplink signal 2516 toward the reconfigurable intelligent surface (RIS) device 2506. The first reconfigurable reflective layer 2508 may be configured to immediately reflect the first uplink signal 2516 toward the base station 2502 as indicated with the reflected signal 2518. As shown in FIG. 25B, the second reconfigurable reflective layer 2510 may be configured to reflect the first uplink signal 2516 toward the base station 2502 after the preconfigured delay as indicated in FIG. 25B with the reflected signal 2520.

In some examples, when the UE 2504 is to transmit control information in a control channel (e.g., PUCCH) in consecutive symbols (e.g., two-symbol PUCCH format 0), the first reconfigurable reflective layer 2508 and the second reconfigurable reflective layer 2510 may be enabled (e.g., turned ON). In other examples, when the UE 2504 is to transmit control information in a control channel (e.g., PUCCH) in one symbol, the first reconfigurable reflective layer 2508 may be enabled and the second reconfigurable reflective layer 2510 may be disabled (e.g., turned OFF).

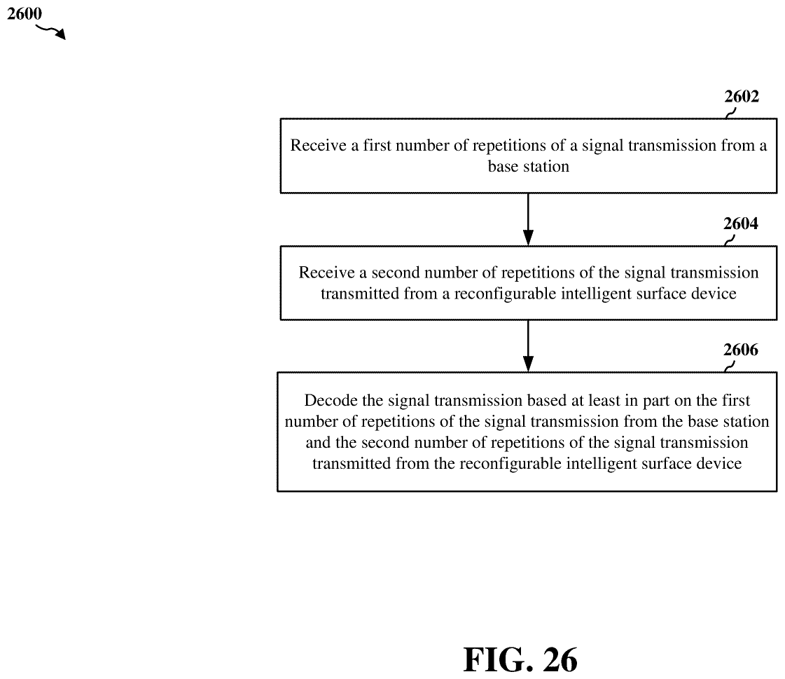

FIG. 26 is a flowchart 2600 of a method of wireless communication. The method may be performed by a UE (e.g., the UE 804, 2504; the apparatus 2902/2902′; the processing system 3014, which may include the memory 360 and which may be the entire UE 804, 2504 or a component of the UE 804, 2504 such as the TX processor 368, the RX processor 356, and/or the controller/processor 359).

At 2602, the UE receives a first number of repetitions of a signal transmission from a base station. For example, with reference to FIG. 12, the base station 802 may transmit a first downlink signal 1110 toward the RIS device 806. The first downlink signal 1110 may be a repetition of a signal transmission. The RIS device 806 may be configured to reflect the first downlink signal 1110 toward the UE 804 as indicated in FIG. 12 with the reflected first downlink signal 1112. The UE 804 may receive the reflected first downlink signal 1112.

At 2604, the UE receives a second number of repetitions of the signal transmission transmitted from a reconfigurable intelligent surface device. For example, with reference to FIG. 12, the RIS device 806 may transmit a second downlink signal 1130 toward the UE 804. The second downlink signal 1130 may be a repetition (e.g., retransmission) of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804. The UE 804 may receive the second downlink signal 1130.

Finally, at 2606, the UE decodes the signal transmission based at least in part on the first number of repetitions of the signal transmission from the base station and the second number of repetitions of the signal transmission transmitted from the reconfigurable intelligent surface device. For example, the UE may decode the signal transmission by performing one or more decoding operations to recover data bits carried in the signal transmission.

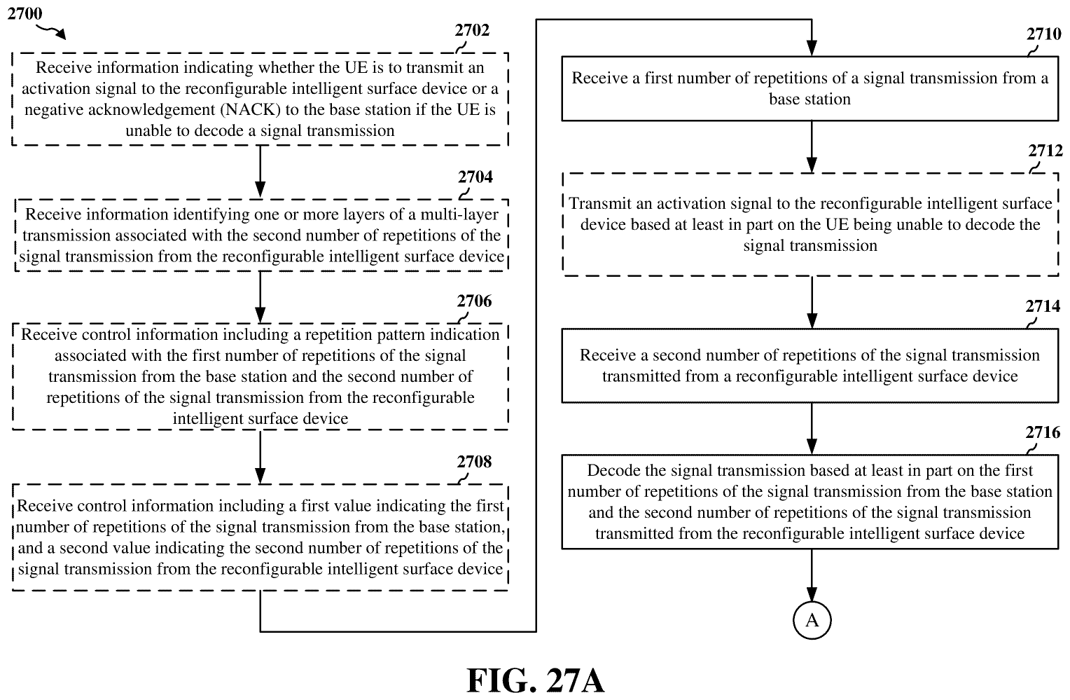

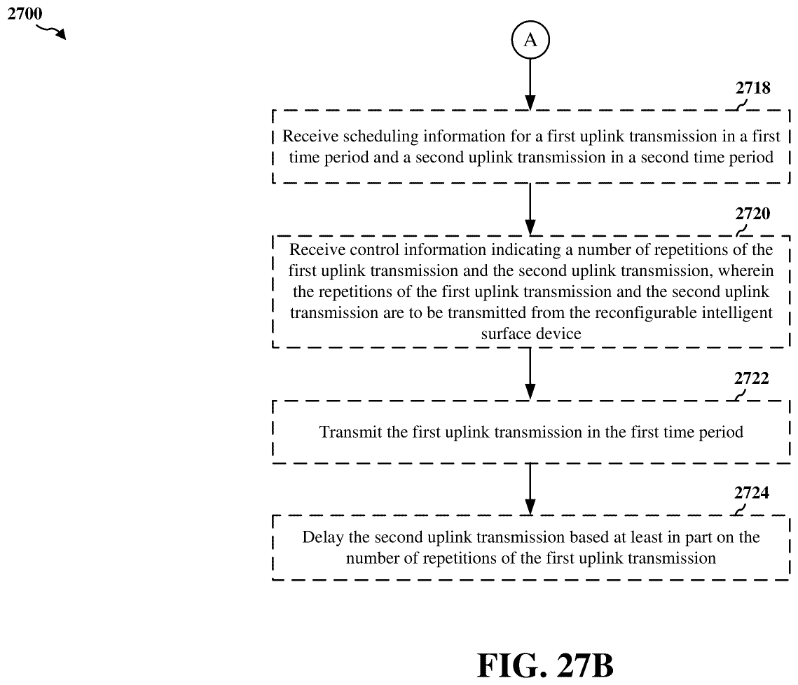

FIG. 27 (including FIGS. 27A and 27B) is a flowchart 2700 of a method of wireless communication. The method may be performed by a UE (e.g., the UE 804, 2504; the apparatus 2902/2902′; the processing system 3014, which may include the memory 360 and which may be the entire UE 804, 2504 or a component of the UE 804, 2504 such as the TX processor 368, the RX processor 356, and/or the controller/processor 359). It should be understood that operations indicated with dashed lines in FIG. 27 represent optional operations.

With reference to FIG. 27A, at 2702, the UE receives information indicating whether the UE is to transmit an activation signal to the reconfigurable intelligent surface device or a negative acknowledgement (NACK) to the base station if the UE is unable to decode the signal transmission.

At 2704, the UE receives information identifying one or more layers of a multi-layer transmission associated with the second number of repetitions of the signal transmission from the reconfigurable intelligent surface device. The UE may receive the information when the first number of repetitions of the signal transmission from the base station and the second number of repetitions of the signal transmission from the reconfigurable intelligent surface device are associated with different layers of a multi-layer transmission.

At 2706, the UE receives control information including a repetition pattern indication associated with the first number of repetitions of the signal transmission from the base station and the second number of repetitions of the signal transmission from the reconfigurable intelligent surface device (e.g., the RIS device 806).

At 2708, the UE receives control information including a first value (e.g., N) indicating the first number of repetitions of the signal transmission from the base station, and a second value (e.g., M−1) indicating the second number of repetitions of the signal transmission from the reconfigurable intelligent surface device.

At 2710, the UE receives a first number of repetitions of a signal transmission from a base station. For example, with reference to FIG. 12, the base station 802 may transmit a first downlink signal 1110 toward the RIS device 806. The first downlink signal 1110 may be a repetition of a signal transmission. The RIS device 806 may be configured to reflect the first downlink signal 1110 toward the UE 804 as indicated in FIG. 12 with the reflected first downlink signal 1112. The UE 804 may receive the reflected first downlink signal 1112.

At 2712, the UE transmits an activation signal to the reconfigurable intelligent surface device based at least in part on the apparatus being unable to decode the signal transmission. For example, with reference to FIG. 12, the UE 804 may transmit the activation signal 1120 to the RIS device 806.

At 2714, the UE receives a second number of repetitions of the signal transmission transmitted from a reconfigurable intelligent surface device. In some aspects, the second number of repetitions of the signal transmission from the reconfigurable intelligent surface device are received in response to the activation signal. For example, with reference to FIG. 12, the RIS device 806 may transmit a second downlink signal 1130 toward the UE 804. The second downlink signal 1130 may be a repetition (e.g., retransmission) of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804. The UE 804 may receive the second downlink signal 1130.

At 2716, the UE decodes the signal transmission based at least in part on the first number of repetitions of the signal transmission from the base station and the second number of repetitions of the signal transmission transmitted from the reconfigurable intelligent surface device. In some examples, the signal transmission is decoded based at least in part on the repetition pattern indication.

At 2718, the UE receives scheduling information for a first uplink transmission in a first time period and a second uplink transmission in a second time period. For example, the first and second uplink transmissions may include uplink control information (UCI) and may be scheduled for transmission in consecutive slots in an uplink control channel, such as PUCCH in accordance with PUCCH format 0.

At 2720, the UE receives control information indicating a number of repetitions of the first uplink transmission and the second uplink transmission, wherein the repetitions of the first uplink transmission and the second uplink transmission are to be transmitted from the reconfigurable intelligent surface device (e.g., the RIS device 806).

At 2722, the UE transmits the first uplink transmission in the first time period. For example, with reference to FIG. 19, the UE may transmit the first uplink transmission 1916 in the ninth symbol 1904.

Finally, at 2724, the UE delays the second uplink transmission based at least in part on the number of repetitions of the first uplink transmission. For example, the UE may delay the second uplink transmission 1918 based at least in part on the number of repetitions of the first uplink transmission 1916. For example, if the RIS device 806 is to transmit two repetitions of the first uplink transmission 1916, the UE 804 may transmit the second uplink transmission 1918 in the twelfth symbol 1910 instead of the tenth symbol 1906 to allow time for the two repetitions of the first uplink transmission 1916 in the tenth and eleventh symbols 1906, 1908.

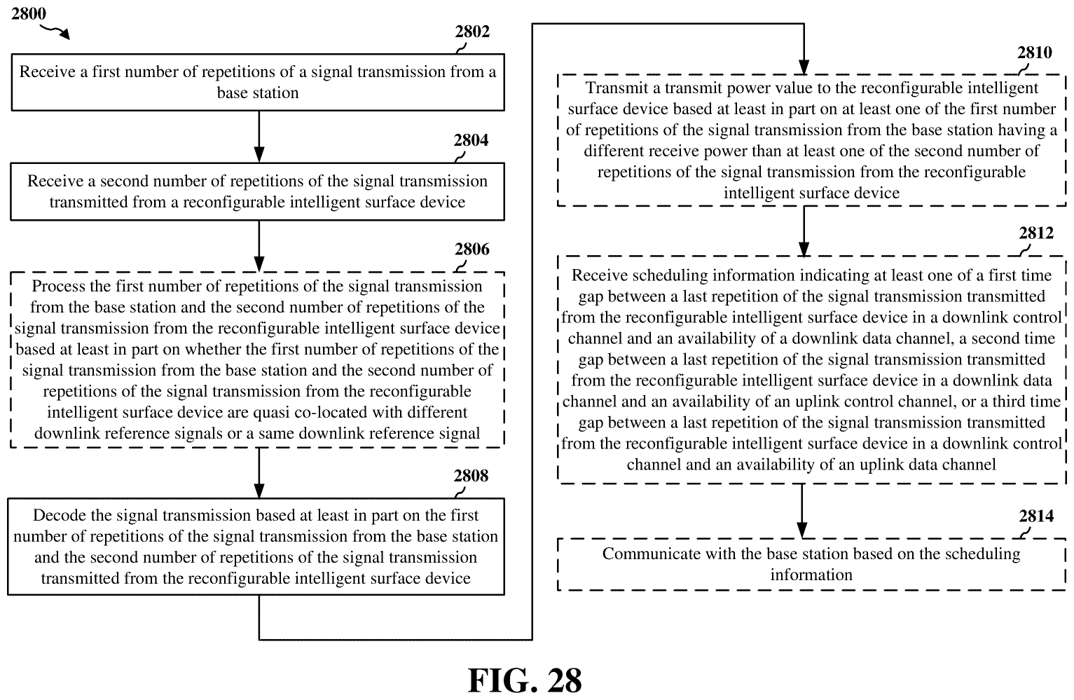

FIG. 28 is a flowchart 2800 of a method of wireless communication. The method may be performed by a UE (e.g., the UE 804, 2504; the apparatus 2902/2902′; the processing system 3014, which may include the memory 360 and which may be the entire UE 804, 2504 or a component of the UE 804, 2504 such as the TX processor 368, the RX processor 356, and/or the controller/processor 359). It should be understood that operations indicated with dashed lines in FIG. 28 represent optional operations.

At 2802, the UE receive a first number of repetitions of a signal transmission from a base station.

At 2804, the UE receives a second number of repetitions of the signal transmission transmitted from a reconfigurable intelligent surface device.

At 2806, the UE processes the first number of repetitions of the signal transmission from the base station and the second number of repetitions of the signal transmission from the reconfigurable intelligent surface device based at least in part on whether the first number of repetitions of the signal transmission from the base station and the second number of repetitions of the signal transmission from the reconfigurable intelligent surface device are quasi co-located with different downlink reference signals or a same downlink reference signal.

For example, with reference to FIGS. 8 and 20, the UE (e.g., the UE 804) may determine whether the first and second repetitions (e.g., the first and second repetitions 2010, 2014) of the signal transmission from the base station (e.g., the base station 802) and the first and second repetitions (e.g., the first and second repetitions 2012, 2016) of the signal transmission from the RIS device (e.g., the RIS device 806) are QCLed with different downlink reference signals or a same downlink reference signal. In some examples, the UE may determine that different downlink reference signals are used for QCL if the first and second repetitions 2010, 2014 of the signal transmission from the base station are QCLed with a reference signal (e.g., CSI-RS) transmitted from the base station, and the first and second repetitions 2012, 2016 of the signal transmission from the RIS device are QCLed with a reference signal (e.g., CSI-RS) transmitted from the RIS device. In other examples, the UE may determine that the same downlink reference signal is used for QCL if the first and second repetitions 2010, 2014 of the signal transmission from the base station and the first and second repetitions 2012, 2016 of the signal transmission from the RIS device are QCLed with a reference signal (e.g., CSI-RS) transmitted from the base station.

For example, the UE 804 may process the first and second repetitions 2010, 2014 of the signal transmission and the first and second repetitions 2012, 2016 of the signal transmission by combining the first and second repetitions 2010, 2014 of the signal transmission and the first and second repetitions 2012, 2016 of the signal transmission based on the appropriate reference signals used for QCL to provide a combined signal 2020.

At 2808, the UE decodes the signal transmission based at least in part on the first number of repetitions of the signal transmission from the base station and the second number of repetitions of the signal transmission transmitted from the reconfigurable intelligent surface device. For example, the UE may decode the signal transmission by performing one or more decoding operations to recover data bits carried in the signal transmission.

At 2810, the UE transmits a transmit power value to the reconfigurable intelligent surface device based at least in part on at least one of the first number of repetitions of the signal transmission from the base station having a different receive power than at least one of the second number of repetitions of the signal transmission from the reconfigurable intelligent surface device. For example, with reference to FIG. 21, the UE may transmit the transmit power value 2108 to the RIS device 806.

At 2812, the UE receives scheduling information indicating at least one of a first time gap (e.g., the KO offset) between a last repetition of the signal transmission transmitted from the reconfigurable intelligent surface device in a downlink control channel and an availability of a downlink data channel, a second time gap (e.g., the K1 offset) between a last repetition of the signal transmission transmitted from the reconfigurable intelligent surface device in a downlink data channel and an availability of an uplink control channel, or a third time gap (e.g., the K2 offset) between a last repetition of the signal transmission transmitted from the reconfigurable intelligent surface device in a downlink control channel and an availability of an uplink data channel.

Finally, at 2814, the UE communicates with the base station based on the scheduling information. For example, the UE may receive a downlink signal transmission from the base station when a downlink channel (e.g., PDCCH/PDSCH) is available or may transmit an uplink signal (e.g., a ACK signal) to the base station when an uplink channel (e.g., PUCCH/PUSCH) is available.

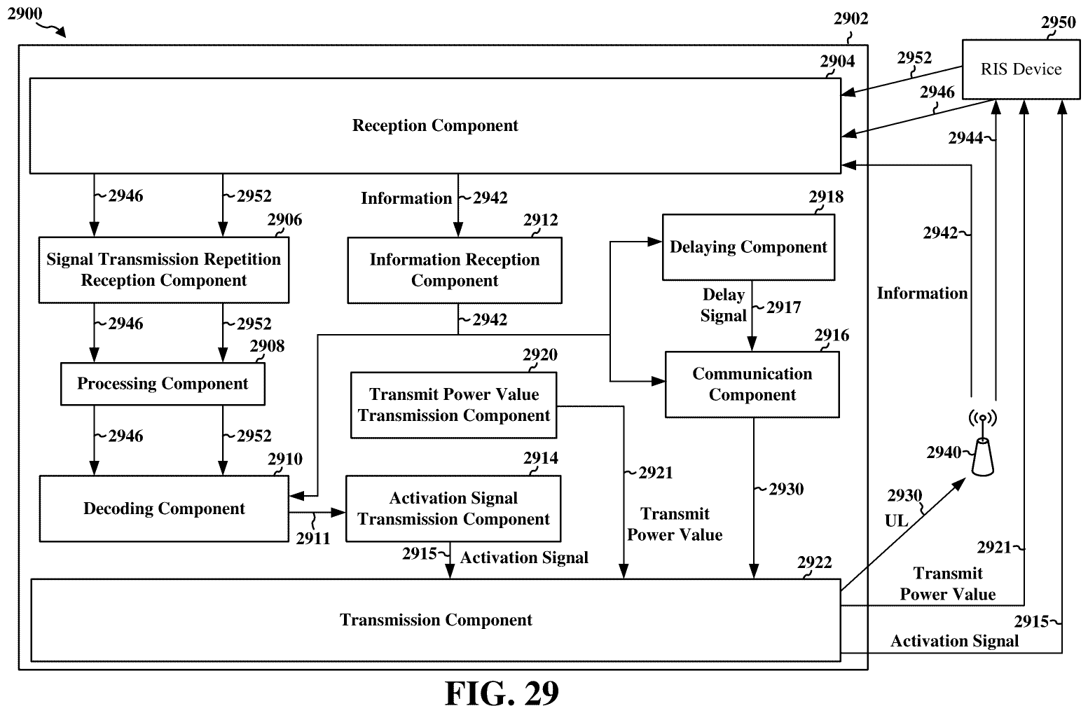

FIG. 29 is a conceptual data flow diagram 2900 illustrating the data flow between different means/components in an example apparatus 2902. The apparatus may be a UE. The apparatus includes a reception component 2904 that receives downlink signals.

The apparatus further includes a signal transmission repetition reception component 2906 that receives (e.g., via the reception component 2904) a first number of repetitions of a signal transmission from a base station and a second number of repetitions of the signal transmission transmitted from a reconfigurable intelligent surface device. For example, the base station 2940 may transmit a repetition of a signal transmission 2944 toward the RIS device 2950. The RIS device 2950 may reflect the repetition of the signal transmission 2944 toward the apparatus 2902 (e.g., shown in FIG. 29 as the reflected repetition of the signal transmission 2946). The signal transmission repetition reception component 2906 may receive the reflected repetition of the signal transmission 2946. Therefore, in FIG. 29, the repetition of the signal transmission 2944 and the reflected repetition of the signal transmission 2946 are considered to be the same signal.

As another example, the signal transmission repetition reception component 2906 further receives a repetition of the signal transmission 2952 transmitted from the RIS device 2950. In some examples, the repetition of the signal transmission 2952 may be the same as the repetition of the signal transmission 2944.

The apparatus further includes a processing component 2908 that processes the first number of repetitions of the signal transmission from the base station (e.g., the reflected repetition of the signal transmission 2946 from base station 2940) and the second number of repetitions of the signal transmission from the RIS device (e.g., the repetition of the signal transmission 2952 transmitted from the RIS device 2950) based at least in part on whether the first number of repetitions of the signal transmission from the base station and the second number of repetitions of the signal transmission from the reconfigurable intelligent surface device are quasi co-located with different downlink reference signals or a same downlink reference signal. For example, the processing component 2908 may receive the reflected repetition of the signal transmission 2946 and the repetition of the signal transmission 2952 transmitted from the RIS device 2950 from the signal transmission repetition reception component 2906.

The apparatus further includes a decoding component 2910 that decodes the signal transmission based at least in part on the first number of repetitions of the signal transmission from the base station (e.g., the reflected repetition of the signal transmission 2946 from base station 2940) and the second number of repetitions of the signal transmission transmitted from the reconfigurable intelligent surface device (e.g., the repetition of the signal transmission 2952 transmitted from the RIS device 2950).

The apparatus further includes an information reception component 2912 that receives information 2942 (e.g., via the reception component) from the base station 2940. In some examples, the information 2942 may include control information containing a first value indicating the first number of repetitions of the signal transmission from the base station, and a second value indicating the second number of repetitions of the signal transmission from the reconfigurable intelligent surface device. In some examples, the information 2942 may include control information containing a repetition pattern indication associated with the first number of repetitions of the signal transmission from the base station and the second number of repetitions of the signal transmission from the reconfigurable intelligent surface device. In some examples, the decoding component 2910 may receive the information 2942 from the information reception component 2912 and may decode the signal transmission based at least in part on the information 2942 (e.g., a repetition pattern indication included in the information 2942).

In some examples, the information 2942 may include scheduling information indicating at least one of: a first time gap between a last repetition of the signal transmission transmitted from the reconfigurable intelligent surface device in a downlink control channel and an availability of a downlink data channel, a second time gap between a last repetition of the signal transmission transmitted from the reconfigurable intelligent surface device in a downlink data channel and an availability of an uplink control channel, or a third time gap between a last repetition of the signal transmission transmitted from the reconfigurable intelligent surface device in a downlink control channel and an availability of an uplink data channel.

In some examples, the information 2942 may include scheduling information for a first uplink transmission in a first time period and a second uplink transmission in a second time period. In some examples, the information 2942 may include control information indicating a number of repetitions of the first uplink transmission and the second uplink transmission, wherein the repetitions of the first uplink transmission and the second uplink transmission are to be transmitted from the reconfigurable intelligent surface device.

In some examples, the information 2942 may include information identifying one or more layers of the multi-layer transmission associated with the second number of repetitions of the signal transmission from the reconfigurable intelligent surface device.

In some examples, the information 2942 may include information indicating whether the apparatus is to transmit an activation signal to the reconfigurable intelligent surface device or a negative acknowledgement (NACK) to the base station if the apparatus is unable to decode the signal transmission.

The apparatus further includes an activation signal transmission component 2914 that transmits an activation signal 2915 to the RIS device 2950 based at least in part on the apparatus being unable to decode the signal transmission. In some examples, the activation signal transmission component 2914 may receive a message 2911 from the decoding component 2910 indicating a failure to decode the signal transmission and may transmit the activation signal 2915 in response to the message 2911.

The apparatus further includes a communication component 2916 that communicates with the base station 2940 based on the scheduling information and transmits the first uplink transmission (e.g., UL transmission 2930) in the first time period (e.g., via the transmission component 2922).

The apparatus further includes a delaying component 2918 that delays (e.g., via a delay signal 2917) the second uplink transmission (e.g., UL transmission 2930) based at least in part on the number of repetitions of the first uplink transmission.

The apparatus further includes a power value transmission component 2920 transmits a transmit power value 2921 to the RIS device 2950 (e.g., via the transmission component 2922) based at least in part on at least one of the first number of repetitions of the signal transmission from the base station 2940 having a different receive power than at least one of the second number of repetitions of the signal transmission from the RIS device 2950.

The apparatus further includes a transmission component 2922 that transmits uplink transmissions (e.g., the UL transmission 2930).

The apparatus may include additional components that perform each of the blocks of the algorithm in the aforementioned flowcharts of FIGS. 26-28. As such, each block in the aforementioned flowcharts of FIGS. 26-28. may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

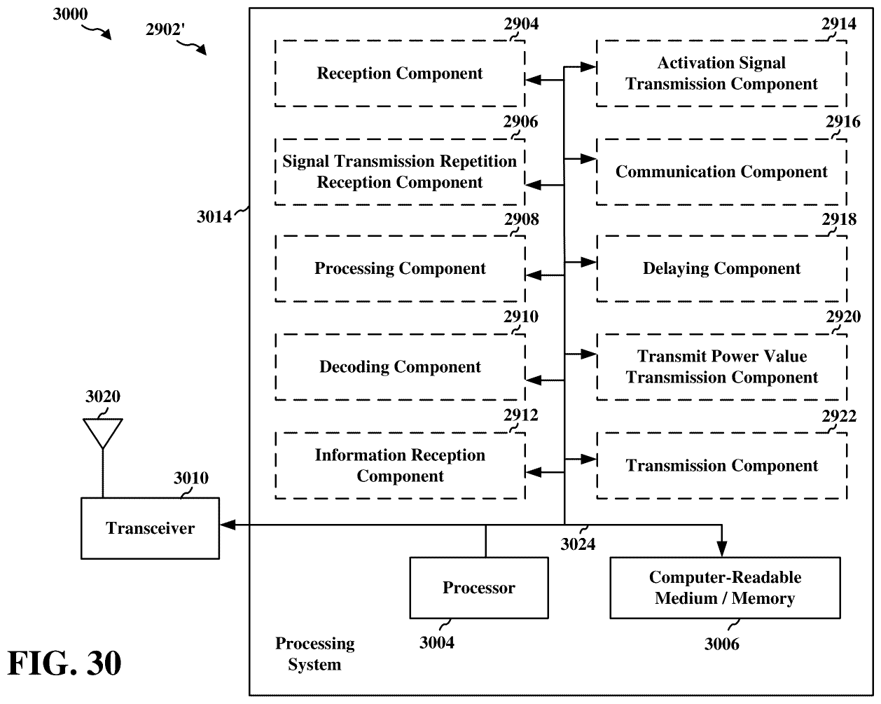

FIG. 30 is a diagram 3000 illustrating an example of a hardware implementation for an apparatus 2902′ employing a processing system 3014. The processing system 3014 may be implemented with a bus architecture, represented generally by the bus 3024. The bus 3024 may include any number of interconnecting buses and bridges depending on the specific application of the processing system 3014 and the overall design constraints. The bus 3024 links together various circuits including one or more processors and/or hardware components, represented by the processor 3004, the components 2904, 2906, 2908, 2910, 2912, 2914, 2916, 2918, 2920, 2922, and the computer-readable medium/memory 3006. The bus 3024 may also link various other circuits such as timing sources, peripherals, voltage regulators, and power management circuits, which are well known in the art, and therefore, will not be described any further.

The processing system 3014 may be coupled to a transceiver 3010. The transceiver 3010 is coupled to one or more antennas 3020. The transceiver 3010 provides a means for communicating with various other apparatus over a transmission medium. The transceiver 3010 receives a signal from the one or more antennas 3020, extracts information from the received signal, and provides the extracted information to the processing system 3014, specifically the reception component 2904. In addition, the transceiver 3010 receives information from the processing system 3014, specifically the transmission component 2922, and based on the received information, generates a signal to be applied to the one or more antennas 3020. The processing system 3014 includes a processor 3004 coupled to a computer-readable medium/memory 3006. The processor 3004 is responsible for general processing, including the execution of software stored on the computer-readable medium/memory 3006. The software, when executed by the processor 3004, causes the processing system 3014 to perform the various functions described supra for any particular apparatus. The computer-readable medium/memory 3006 may also be used for storing data that is manipulated by the processor 3004 when executing software. The processing system 3014 further includes at least one of the components 2904, 2906, 2908, 2910, 2912, 2914, 2916, 2918, 2920, 2922. The components may be software components running in the processor 3004, resident/stored in the computer readable medium/memory 3006, one or more hardware components coupled to the processor 3004, or some combination thereof. The processing system 3014 may be a component of the UE 350 and may include the memory 360 and/or at least one of the TX processor 368, the RX processor 356, and the controller/processor 359. Alternatively, the processing system 3014 may be the entire UE (e.g., see 350 of FIG. 3).

In one configuration, the apparatus 2902/2902′ for wireless communication includes means for receiving a first number of repetitions of a signal transmission from a base station, means for receiving a second number of repetitions of the signal transmission transmitted from a reconfigurable intelligent surface device, means for decoding the signal transmission based at least in part on the first number of repetitions of the signal transmission from the base station and the second number of repetitions of the signal transmission transmitted from the reconfigurable intelligent surface device, means for receiving control information including a first value indicating the first number of repetitions of the signal transmission from the base station, and a second value indicating the second number of repetitions of the signal transmission from the reconfigurable intelligent surface device, means for receiving control information including a repetition pattern indication associated with the first number of repetitions of the signal transmission from the base station and the second number of repetitions of the signal transmission from the reconfigurable intelligent surface device, means for processing the first number of repetitions of the signal transmission from the base station and the second number of repetitions of the signal transmission from the reconfigurable intelligent surface device based at least in part on whether the first number of repetitions of the signal transmission from the base station and the second number of repetitions of the signal transmission from the reconfigurable intelligent surface device are quasi co-located with different downlink reference signals or a same downlink reference signal, means for receiving scheduling information indicating at least one of: a first time gap between a last repetition of the signal transmission transmitted from the reconfigurable intelligent surface device in a downlink control channel and an availability of a downlink data channel, a second time gap between a last repetition of the signal transmission transmitted from the reconfigurable intelligent surface device in a downlink data channel and an availability of an uplink control channel, or a third time gap between a last repetition of the signal transmission transmitted from the reconfigurable intelligent surface device in a downlink control channel and an availability of an uplink data channel, means for communicating with the base station based on the scheduling information, means for receiving scheduling information for a first uplink transmission in a first time period and a second uplink transmission in a second time period, means for receiving control information indicating a number of repetitions of the first uplink transmission and the second uplink transmission, wherein the repetitions of the first uplink transmission and the second uplink transmission are to be transmitted from the reconfigurable intelligent surface device, means for transmitting the first uplink transmission in the first time period, means for delaying the second uplink transmission based at least in part on the number of repetitions of the first uplink transmission, means for transmitting a transmit power value to the reconfigurable intelligent surface device based at least in part on at least one of the first number of repetitions of the signal transmission from the base station having a different receive power than at least one of the second number of repetitions of the signal transmission from the reconfigurable intelligent surface device, means for transmitting an activation signal to the reconfigurable intelligent surface device based at least in part on the apparatus being unable to decode the signal transmission, wherein the second number of repetitions of the signal transmission from the reconfigurable intelligent surface device are received in response to the activation signal, means for receiving information identifying one or more layers of the multi-layer transmission associated with the second number of repetitions of the signal transmission from the reconfigurable intelligent surface device, means for receiving information indicating whether the apparatus is to transmit an activation signal to the reconfigurable intelligent surface device or a negative acknowledgement (NACK) to the base station if the apparatus is unable to decode the signal transmission.

The aforementioned means may be one or more of the aforementioned components of the apparatus 2902 and/or the processing system 3014 of the apparatus 2902′ configured to perform the functions recited by the aforementioned means. As described supra, the processing system 3014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

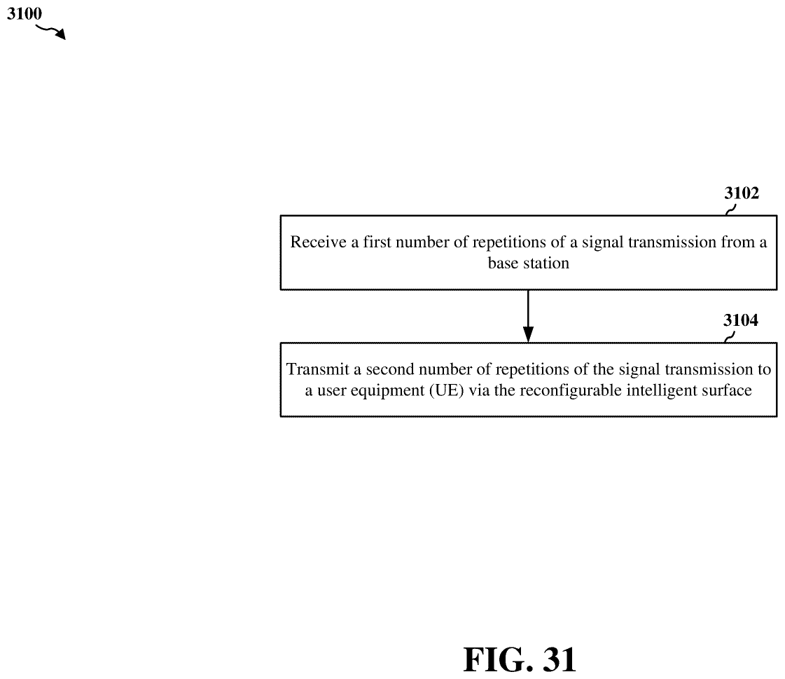

FIG. 31 is a flowchart 3100 of a method of wireless communication. The method may be performed by a reconfigurable intelligent surface (RIS) device (e.g., the RIS device 806, 2506; the apparatus 3302/3302′; the processing system 3414, which may include the memory 376 and which may be the entire RIS device 806, 2506 or a component of the RIS device 806, 2506, such as the TX processor 316, the RX processor 370, and/or the controller/processor 375).

At 3102, the RIS device 806 receives a first number of repetitions of a signal transmission from a base station. For example, with reference to FIG. 12, the base station 802 may transmit a first downlink signal 1110 toward the RIS device 806. The first downlink signal 1110 may be a repetition of a signal transmission. The RIS device 806 may receive the first downlink signal 1110. The RIS device 806 may be configured to sample the first downlink signal 1110 and store in-phase and quadrature signal information for subsequent retransmission of the first downlink signal 1110.

Finally, at 3104, the RIS device 806 transmits a second number of repetitions of the signal transmission to a user equipment (UE) via the reconfigurable intelligent surface. For example, with reference to FIG. 12, the RIS device 806 may transmit the second downlink signal 1130 toward the UE 804. The second downlink signal 1130 may be a repetition (e.g., retransmission) of the first downlink signal 1110 based on the previously stored in-phase and quadrature signal information of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804.

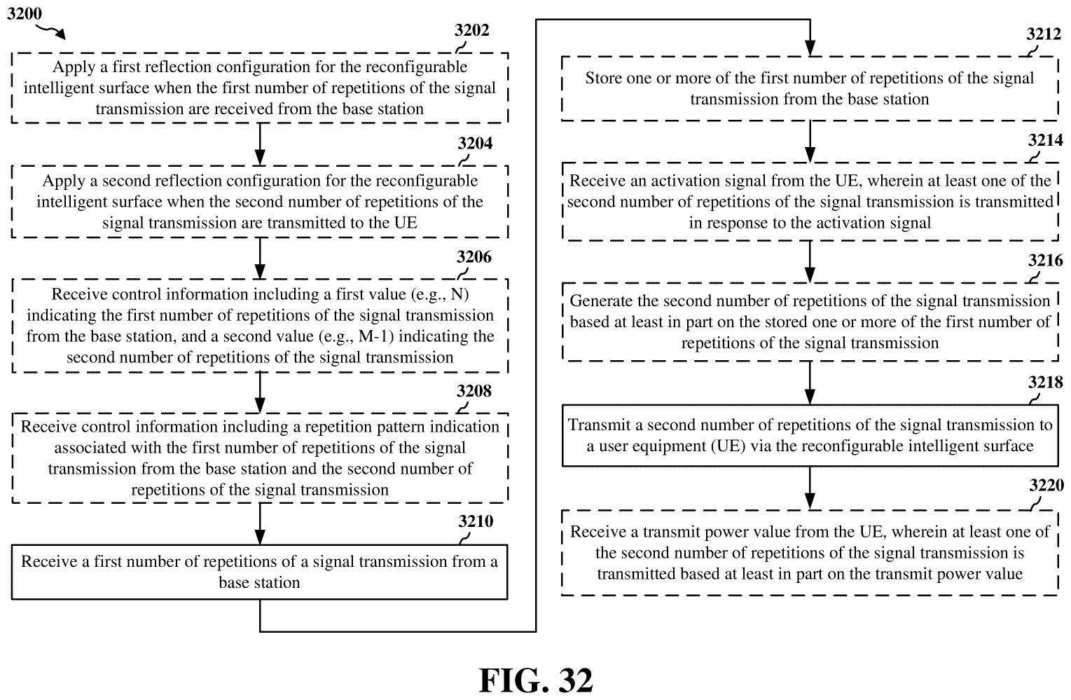

FIG. 32 is a flowchart 3200 of a method of wireless communication. The method may be performed by a reconfigurable intelligent surface (RIS) device (e.g., the RIS device 806, 2506; the apparatus 3302/3302′; the processing system 3414, which may include the memory 376 and which may be the entire RIS device 806, 2506 or a component of the RIS device 806, 2506, such as the TX processor 316, the RX processor 370, and/or the controller/processor 375). It should be understood that operations indicated with dashed lines in FIG. 32 represent optional operations.

At 3202, the reconfigurable intelligent surface (RIS) device applies a first reflection configuration for the reconfigurable intelligent surface when the first number of repetitions of the signal transmission are received from the base station. For example, with reference to FIG. 13B, the RIS device 806 may apply a far-field reflection configuration for the RIS 808 when the base station 802 transmits a beam (e.g., a beamformed signal transmission using the beam 1334) toward the surface 810 of the RIS 808. The far-field reflection configuration may reflect the beam 1334 toward the UE 804 via the beam 1332.

At 3204, the reconfigurable intelligent surface (RIS) device applies a second reflection configuration for the reconfigurable intelligent surface when the second number of repetitions of the signal transmission are transmitted to the UE. For example, with reference to FIG. 13A, the RIS device 806 may apply a near-field reflection configuration for the RIS 808 when the transmitter 816 transmits a beam (e.g., beam 1330) toward the surface 810 of the RIS 808. The near-field reflection configuration may reflect the beam 1330 toward the UE 804 via the beam 1328.

At 3206, the reconfigurable intelligent surface (RIS) device receives control information including a first value (e.g., N) indicating the first number of repetitions of the signal transmission from the base station, and a second value (e.g., M−1) indicating the second number of repetitions of the signal transmission.

At 3208, the reconfigurable intelligent surface (RIS) device receives control information including a repetition pattern indication associated with the first number of repetitions of the signal transmission from the base station and the second number of repetitions of the signal transmission. In some examples, the second number of repetitions of the signal transmission are transmitted based at least in part on the repetition pattern.

At 3210, the reconfigurable intelligent surface (RIS) device receives a first number of repetitions of a signal transmission from a base station. For example, with reference to FIG. 12, the base station 802 may transmit a first downlink signal 1110 toward the RIS device 806. The first downlink signal 1110 may be a repetition of a signal transmission. The RIS device 806 may receive the first downlink signal 1110.

At 3212, the reconfigurable intelligent surface (RIS) device stores one or more of the first number of repetitions of the signal transmission from the base station. For example, the RIS device 806 may be configured to sample the first downlink signal 1110 from the base station 802 and store in-phase and quadrature signal information for subsequent retransmission of the first downlink signal 1110.

At 3214, the reconfigurable intelligent surface (RIS) device receives an activation signal from the UE, wherein at least one of the second number of repetitions of the signal transmission is transmitted in response to the activation signal. For example, with reference to FIG. 12, the RIS device 806 may receive the activation signal 1120 from the UE 804.

At 3216, the reconfigurable intelligent surface (RIS) device generates the second number of repetitions of the signal transmission based at least in part on the stored one or more of the first number of repetitions of the signal transmission. For example, the RIS device 806 may generate the second number of repetitions of the signal transmission (e.g., the repetition of the signal transmission 3346) using the previously sampled and stored in-phase and quadrature signal information.

At 3218, the reconfigurable intelligent surface (RIS) device transmits a second number of repetitions of the signal transmission to a user equipment (UE) via the reconfigurable intelligent surface. For example, with reference to FIG. 12, the RIS device 806 may transmit the second downlink signal 1130 toward the UE 804. The second downlink signal 1130 may be a repetition (e.g., retransmission) of the first downlink signal 1110 based on the previously stored in-phase and quadrature signal information of the first downlink signal 1110. For example, the RIS device 806 may be configured to transmit the second downlink signal 1130 toward the surface 810 of the RIS device 806. The RIS 808 of the RIS device 806 may be configured to reflect the second downlink signal 1130 toward the UE 804.

At 3220, the reconfigurable intelligent surface (RIS) device receives a transmit power value from the UE, wherein at least one of the second number of repetitions of the signal transmission is transmitted based at least in part on the transmit power value. For example, with reference to FIG. 21, the RIS device 806 may receive the transmit power value 2108 from the UE 804.

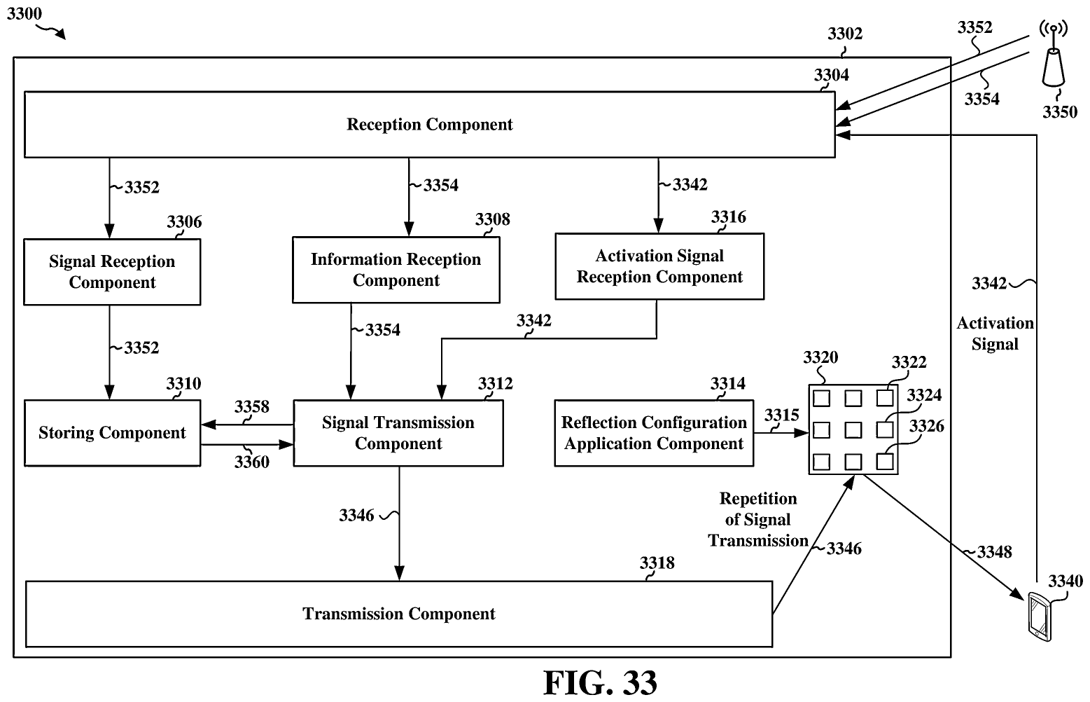

FIG. 33 is a conceptual data flow diagram 3300 illustrating the data flow between different means/components in an example apparatus 3302. The apparatus may be a reconfigurable intelligent surface (RIS) device. The apparatus includes a reception component 3304 that receives signal transmissions, such as downlink signals from the base station 3350 and uplink signals from the UE 3340.

The apparatus further includes a signal reception component 3306 that receives a first number of repetitions of a signal transmission from the base station 3350. For example, the base station 3350 may transmit a repetition of a signal transmission 3352 toward the apparatus 3302. The signal reception component 3306 may receive (e.g., via the reception component 3304) the repetition of the signal transmission 3352.

The apparatus further includes an information reception component 3308 that receives information 3354 from the base station 3350 (e.g., via the reception component 3304). In some examples, the information 3354 includes control information containing a repetition pattern indication associated with the first number of repetitions of the signal transmission from the base station and a second number of repetitions of the signal transmission from the apparatus 3302.

In some examples, the information 3354 includes control information containing a first value indicating the first number of repetitions of the signal transmission from the base station 3350, and a second value indicating the second number of repetitions of the signal transmission from the apparatus 3302.

The apparatus further includes a storing component 3310 that stores one or more of the first number of repetitions of the signal transmission from the base station 3350.

The apparatus further includes a signal transmission component 3312 that generates the second number of repetitions of the signal transmission (e.g., the repetition of the signal transmission 3346) based at least in part on the stored one or more of the first number of repetitions of the signal transmission. For example, the signal transmission component 3312 may transmit a command 3358 to the storing component 3310 to retrieve in-phase and quadrature signal information of the first number of repetitions of the signal transmission (e.g., the repetition of the signal transmission 3352). The signal transmission component 3312 may receive a message 3360 including in-phase and quadrature signal information of the first number of repetitions of the signal transmission in response to the command 3358 and may generate the second number of repetitions of the signal transmission (e.g., the repetition of the signal transmission 3346) using the in-phase and quadrature signal information.

The apparatus further includes an activation signal reception component 3316 that receives an activation signal 3342 from the UE 3340 (e.g., via the reception component 3304).

The apparatus further includes a reflection configuration application component 3314 that applies a first reflection configuration for the RIS 3320 when the first number of repetitions of the signal transmission are received from the base station 3350, and applies a second reflection configuration for the RIS 3320 when the second number of repetitions of the signal transmission are transmitted to the UE 3340.

The RIS 3320 may include a grid of reflective elements, such as the reflective elements 3322, 3324, 3326. In some examples, the RIS 3320 may not include active antenna units. Therefore, the RIS 3320 may be generally considered a passive device and may have negligible power consumption. Each of the reflective elements of the RIS 3320 may be electrically configured (e.g., via a configuration signal 3315) to reflect incident signals (e.g., beamformed radio frequency (RF) signals) in a desired direction.

The apparatus further includes a transmission component 3318 that transmits a second number of repetitions of the signal transmission to UE 3340 via the RIS 3320. For example, the transmission component 3318 may transmit the repetition of the signal transmission 3346 toward the RIS 3320. The RIS 3320 may be configured to reflect the repetition of the signal transmission 3346 toward the UE 3340 as indicated in FIG. 33 with the reflected signal 3348.

The apparatus may include additional components that perform each of the blocks of the algorithm in the aforementioned flowcharts of FIGS. 31 and 32. As such, each block in the aforementioned flowcharts of FIGS. 31 and 32 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

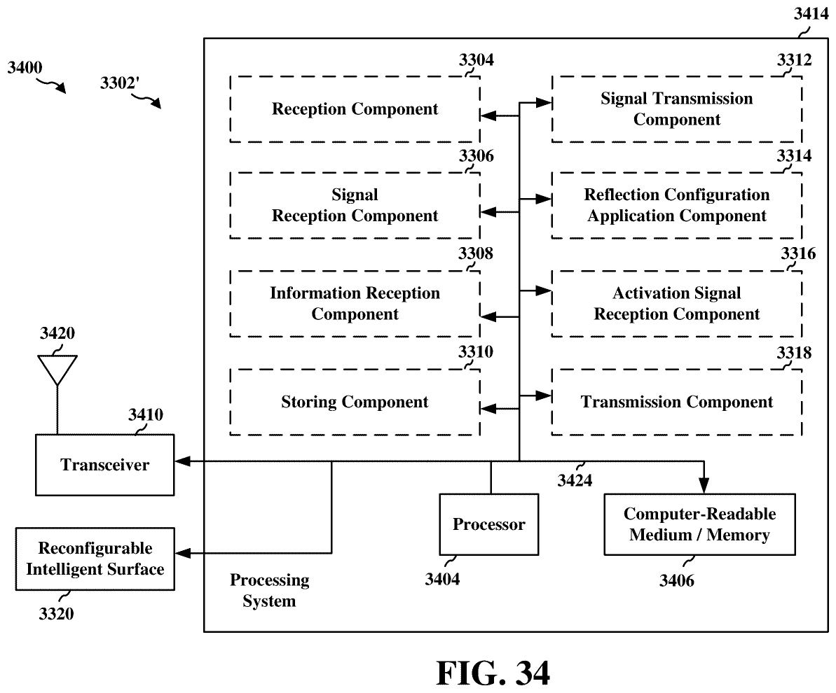

FIG. 34 is a diagram 3400 illustrating an example of a hardware implementation for an apparatus 3302′ employing a processing system 3414. The processing system 3414 may be implemented with a bus architecture, represented generally by the bus 3424. The bus 3424 may include any number of interconnecting buses and bridges depending on the specific application of the processing system 3414 and the overall design constraints. The bus 3424 links together various circuits including one or more processors and/or hardware components, represented by the processor 3404, the components 3304, 3306, 3308, 3310, 3312, 3314, 3316, 3318, and the computer-readable medium/memory 3406. The bus 3424 may also link various other circuits such as timing sources, peripherals, voltage regulators, and power management circuits, which are well known in the art, and therefore, will not be described any further.

The processing system 3414 may be coupled to the reconfigurable intelligent surface (RIS) 3320 and a transceiver 3410. The transceiver 3410 is coupled to one or more antennas 3420. The transceiver 3410 provides a means for communicating with various other apparatus over a transmission medium. The transceiver 3410 receives a signal from the one or more antennas 3420, extracts information from the received signal, and provides the extracted information to the processing system 3414, specifically the reception component 3304. In addition, the transceiver 3410 receives information from the processing system 3414, specifically the transmission component 3318, and based on the received information, generates a signal to be applied to the one or more antennas 3420. The reconfigurable intelligent surface (RIS) 3320 (e.g., the RIS 808 in FIG. 8) may include a grid of reflective elements that may be electronically configured to reflect incident signal transmissions (e.g., beamformed radio frequency (RF) signals) in a desired direction.

The processing system 3414 includes a processor 3404 coupled to a computer-readable medium/memory 3406. The processor 3404 is responsible for general processing, including the execution of software stored on the computer-readable medium/memory 3406. The software, when executed by the processor 3404, causes the processing system 3414 to perform the various functions described supra for any particular apparatus. The computer-readable medium/memory 3406 may also be used for storing data that is manipulated by the processor 3404 when executing software. The processing system 3414 further includes at least one of the components 3304, 3306, 3308, 3310, 3312, 3314, 3316, 3318. The components may be software components running in the processor 3404, resident/stored in the computer readable medium/memory 3406, one or more hardware components coupled to the processor 3404, or some combination thereof. The processing system 3414 may be a component of the RIS device 806. Alternatively, the processing system 3414 may be the entire reconfigurable intelligent surface (RIS) device (e.g., see 806 of FIG. 8).

In one configuration, the apparatus 3302/3302′ for wireless communication includes means for receiving a first number of repetitions of a signal transmission from a base station, means for transmitting a second number of repetitions of the signal transmission to a user equipment (UE) via the reconfigurable intelligent surface, means for storing one or more of the first number of repetitions of the signal transmission from the base station, means for generating the second number of repetitions of the signal transmission based at least in part on the stored one or more of the first number of repetitions of the signal transmission, means for applying a first reflection configuration for the reconfigurable intelligent surface when the first number of repetitions of the signal transmission are received from the base station, means for applying a second reflection configuration for the reconfigurable intelligent surface when the second number of repetitions of the signal transmission are transmitted to the UE, means for receiving control information including: a repetition pattern indication associated with the first number of repetitions of the signal transmission from the base station and the second number of repetitions of the signal transmission, means for receiving control information including a first value indicating the first number of repetitions of the signal transmission from the base station, and a second value indicating the second number of repetitions of the signal transmission, means for receiving an activation signal from the UE.

The aforementioned means may be one or more of the aforementioned components of the apparatus 3302 and/or the processing system 3414 of the apparatus 3302′ configured to perform the functions recited by the aforementioned means. As described supra, the processing system 3414 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The following provides an overview of aspects of the present disclosure:

Aspect 1: A method of wireless communication, comprising: receiving a first number of repetitions of a signal transmission from a base station; receiving a second number of repetitions of the signal transmission transmitted from a reconfigurable intelligent surface device; and decoding the signal transmission based at least in part on the first number of repetitions of the signal transmission from the base station and the second number of repetitions of the signal transmission transmitted from the reconfigurable intelligent surface device.

Aspect 2: The method of aspect 1, further comprising: receiving control information including a first value indicating the first number of repetitions of the signal transmission from the base station, and a second value indicating the second number of repetitions of the signal transmission from the reconfigurable intelligent surface device.

Aspect 3: The method of aspect 1 or 2, further comprising: receiving control information including a repetition pattern indication associated with the first number of repetitions of the signal transmission from the base station and the second number of repetitions of the signal transmission from the reconfigurable intelligent surface device, wherein the signal transmission is decoded based at least in part on the repetition pattern indication.

Aspect 4: The method of any of aspects 1 through 3, wherein the repetition pattern indication indicates an interleaved repetition pattern where the first number of repetitions of the signal transmission from the base station are interleaved with the second number of repetitions of the signal transmission from the reconfigurable intelligent surface device.

Aspect 5: The method of any of aspects 1 through 3, wherein the repetition pattern indication indicates a consecutive repetition pattern where the first number of repetitions of the signal transmission from the base station are scheduled in a first consecutive order, and the second number of repetitions of the signal transmission from the reconfigurable intelligent surface device are scheduled in a second consecutive order.

Aspect 6: The method of any of aspects 1 through 5, further comprising: processing the first number of repetitions of the signal transmission from the base station and the second number of repetitions of the signal transmission from the reconfigurable intelligent surface device based at least in part on whether the first number of repetitions of the signal transmission from the base station and the second number of repetitions of the signal transmission from the reconfigurable intelligent surface device are quasi co-located with different downlink reference signals or a same downlink reference signal.

Aspect 7: The method of any of aspects 1 through 6, further comprising: receiving scheduling information indicating at least one of: a first time gap between a last repetition of the signal transmission transmitted from the reconfigurable intelligent surface device in a downlink control channel and an availability of a downlink data channel, a second time gap between a last repetition of the signal transmission transmitted from the reconfigurable intelligent surface device in a downlink data channel and an availability of an uplink control channel, or a third time gap between a last repetition of the signal transmission transmitted from the reconfigurable intelligent surface device in a downlink control channel and an availability of an uplink data channel; and communicate with the base station based on the scheduling information.

Aspect 8: The method of any of aspects 1 through 7, further comprising: receiving scheduling information for a first uplink transmission in a first time period and a second uplink transmission in a second time period, receiving control information indicating a number of repetitions of the first uplink transmission and the second uplink transmission, wherein the repetitions of the first uplink transmission and the second uplink transmission are to be transmitted from the reconfigurable intelligent surface device, transmitting the first uplink transmission in the first time period, and delaying the second uplink transmission based at least in part on the number of repetitions of the first uplink transmission.

Aspect 9: The method of any of aspects 1 through 8, further comprising: transmitting a transmit power value to the reconfigurable intelligent surface device based at least in part on at least one of the first number of repetitions of the signal transmission from the base station having a different receive power than at least one of the second number of repetitions of the signal transmission from the reconfigurable intelligent surface device.

Aspect 10: The method of any of aspects 1 through 9, further comprising: transmitting an activation signal to the reconfigurable intelligent surface device based at least in part on the apparatus being unable to decode the signal transmission, wherein the second number of repetitions of the signal transmission from the reconfigurable intelligent surface device are received in response to the activation signal.

Aspect 11: The method of any of aspects 1 through 10, wherein the activation signal includes information that enables the reconfigurable intelligent surface device to identify the signal transmission to be repeated.

Aspect 12: The method of any of aspects 1 through 11, wherein the first number of repetitions of the signal transmission from the base station and the second number of repetitions of the signal transmission from the reconfigurable intelligent surface device are associated with different layers of a multi-layer transmission, further comprising: receiving information identifying one or more layers of the multi-layer transmission associated with the second number of repetitions of the signal transmission from the reconfigurable intelligent surface device.

Aspect 13: The method of any of aspects 1 through 12, further comprising: receiving information indicating whether the apparatus is to transmit an activation signal to the reconfigurable intelligent surface device or a negative acknowledgement (NACK) to the base station if the apparatus is unable to decode the signal transmission.

Aspect 14: An apparatus for wireless communication, comprising: a memory; and at least one processor coupled to the memory and configured to perform a method of any one of aspects 1 through 13.

Aspect 15: An apparatus for wireless communication comprising at least one means for performing a method of any one of aspects 1 through 13.

Aspect 16: A computer-readable medium storing computer executable code, the code when executed by a processor cause the processor to perform a method of any one of aspects 1 through 13.

Aspect 17: A method of wireless communication, comprising: receiving a first number of repetitions of a signal transmission from a base station; and transmitting a second number of repetitions of the signal transmission to a user equipment (UE) via the reconfigurable intelligent surface.

Aspect 18: The method of aspect 17, further comprising: storing one or more of the first number of repetitions of the signal transmission from the base station; and generating the second number of repetitions of the signal transmission based at least in part on the stored one or more of the first number of repetitions of the signal transmission.

Aspect 19: The method of aspect 17 or 18, further comprising: applying a first reflection configuration for the reconfigurable intelligent surface when the first number of repetitions of the signal transmission are received from the base station; and applying a second reflection configuration for the reconfigurable intelligent surface when the second number of repetitions of the signal transmission are transmitted to the UE.

Aspect 20: The method of any of aspects 17 through 19, further comprising: receiving control information including: a repetition pattern indication associated with the first number of repetitions of the signal transmission from the base station and the second number of repetitions of the signal transmission, wherein the second number of repetitions of the signal transmission are transmitted based at least in part on the repetition pattern.

Aspect 21: The method of any of aspects 17 through 20, further comprising: receiving control information including a first value indicating the first number of repetitions of the signal transmission from the base station, and a second value indicating the second number of repetitions of the signal transmission.

Aspect 22: The method of any of aspects 17 through 21, further comprising: receiving an activation signal from the UE, wherein at least one of the second number of repetitions of the signal transmission is transmitted in response to the activation signal.

Aspect 23: An apparatus for wireless communication, comprising: a memory; and at least one processor coupled to the memory and configured to perform a method of any one of aspects 17 through 22.

Aspect 24: An apparatus for wireless communication comprising at least one means for performing a method of any one of aspects 17 through 22.

Aspect 25: A computer-readable medium storing computer executable code, the code when executed by a processor cause the processor to perform a method of any one of aspects 17 through 22.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive a first number of repetitions of a signal transmission from a base station;
receive a second number of repetitions of the signal transmission transmitted from a reconfigurable intelligent surface device; and
decode the signal transmission based at least in part on the first number of repetitions of the signal transmission from the base station and the second number of repetitions of the signal transmission transmitted from the reconfigurable intelligent surface device.

2. The apparatus of claim 1, wherein the at least one processor is further configured to:
receive control information including a first value indicating the first number of repetitions of the signal transmission from the base station, and a second value indicating the second number of repetitions of the signal transmission from the reconfigurable intelligent surface device.

3. The apparatus of claim 1, wherein the at least one processor is further configured to:
receive control information including a repetition pattern indication associated with the first number of repetitions of the signal transmission from the base station and the second number of repetitions of the signal transmission from the reconfigurable intelligent surface device,
wherein the signal transmission is decoded based at least in part on the repetition pattern indication.

4. The apparatus of claim 3, wherein the repetition pattern indication indicates an interleaved repetition pattern where the first number of repetitions of the signal transmission from the base station are interleaved with the second number of repetitions of the signal transmission from the reconfigurable intelligent surface device.

5. The apparatus of claim 3, wherein the repetition pattern indication indicates a consecutive repetition pattern where the first number of repetitions of the signal transmission from the base station are scheduled in a first consecutive order, and the second number of repetitions of the signal transmission from the reconfigurable intelligent surface device are scheduled in a second consecutive order.

6. The apparatus of claim 1, wherein the at least one processor is further configured to:
process the first number of repetitions of the signal transmission from the base station and the second number of repetitions of the signal transmission from the reconfigurable intelligent surface device based at least in part on whether the first number of repetitions of the signal transmission from the base station and the second number of repetitions of the signal transmission from the reconfigurable intelligent surface device are quasi co-located with different downlink reference signals or a same downlink reference signal.

7. The apparatus of claim 1, wherein at least one processor is further configured to:
receive scheduling information indicating at least one of:
a first time gap between a last repetition of the signal transmission transmitted from the reconfigurable intelligent surface device in a downlink control channel and an availability of a downlink data channel,
a second time gap between a last repetition of the signal transmission transmitted from the reconfigurable intelligent surface device in a downlink data channel and an availability of an uplink control channel, or
a third time gap between a last repetition of the signal transmission transmitted from the reconfigurable intelligent surface device in a downlink control channel and an availability of an uplink data channel; and
communicate with the base station based on the scheduling information.

8. The apparatus of claim 1, wherein the at least one processor is further configured to:
receive scheduling information for a first uplink transmission in a first time period and a second uplink transmission in a second time period;
receive control information indicating a number of repetitions of the first uplink transmission and the second uplink transmission, wherein the repetitions of the first uplink transmission and the second uplink transmission are to be transmitted from the reconfigurable intelligent surface device;
transmit the first uplink transmission in the first time period; and
delay the second uplink transmission based at least in part on the number of repetitions of the first uplink transmission.

9. The apparatus of claim 1, wherein the at least one processor is further configured to:
transmit a transmit power value to the reconfigurable intelligent surface device based at least in part on at least one of the first number of repetitions of the signal transmission from the base station having a different receive power than at least one of the second number of repetitions of the signal transmission from the reconfigurable intelligent surface device.

10. The apparatus of claim 1, wherein the at least one processor is further configured to:
transmit an activation signal to the reconfigurable intelligent surface device based at least in part on the apparatus being unable to decode the signal transmission, wherein the second number of repetitions of the signal transmission from the reconfigurable intelligent surface device are received in response to the activation signal.

11. The apparatus of claim 10, wherein the activation signal includes information that enables the reconfigurable intelligent surface device to identify the signal transmission to be repeated.

12. The apparatus of claim 1, wherein the first number of repetitions of the signal transmission from the base station and the second number of repetitions of the signal transmission from the reconfigurable intelligent surface device are associated with different layers of a multi-layer transmission, wherein the at least one processor is further configured to:
receive information identifying one or more layers of the multi-layer transmission associated with the second number of repetitions of the signal transmission from the reconfigurable intelligent surface device.

13. The apparatus of claim 1, wherein the at least one processor is further configured to:
receive information indicating whether the apparatus is to transmit an activation signal to the reconfigurable intelligent surface device or a negative acknowledgement (NACK) to the base station if the apparatus is unable to decode the signal transmission.

14. A method of wireless communication for a user equipment (UE), comprising:
receiving a first number of repetitions of a signal transmission from a base station;
receiving a second number of repetitions of the signal transmission transmitted from a reconfigurable intelligent surface device; and
decoding the signal transmission based at least in part on the first number of repetitions of the signal transmission from the base station and the second number of repetitions of the signal transmission transmitted from the reconfigurable intelligent surface device.

15. The method of claim 14, further comprising:
receiving control information including a first value indicating the first number of repetitions of the signal transmission from the base station, and a second value indicating the second number of repetitions of the signal transmission from the reconfigurable intelligent surface device.

16. The method of claim 14, further comprising:
receiving control information including a repetition pattern indication associated with the first number of repetitions of the signal transmission from the base station and the second number of repetitions of the signal transmission from the reconfigurable intelligent surface device,
wherein the signal transmission is decoded based at least in part on the repetition pattern indication.

17. The method of claim 14, further comprising:
processing the first number of repetitions of the signal transmission from the base station and the second number of repetitions of the signal transmission from the reconfigurable intelligent surface device based at least in part on whether the first number of repetitions of the signal transmission from the base station and the second number of repetitions of the signal transmission from the reconfigurable intelligent surface device are quasi co-located with different downlink reference signals or a same downlink reference signal.

18. The method of claim 14, further comprising:
receiving scheduling information indicating at least one of:
a first time gap between a last repetition of the signal transmission transmitted from the reconfigurable intelligent surface device in a downlink control channel and an availability of a downlink data channel,
a second time gap between a last repetition of the signal transmission transmitted from the reconfigurable intelligent surface device in a downlink data channel and an availability of an uplink control channel, or
a third time gap between a last repetition of the signal transmission transmitted from the reconfigurable intelligent surface device in a downlink control channel and an availability of an uplink data channel; and
communicating with the base station based on the scheduling information.

19. The method of claim 14, further comprising:
receiving scheduling information for a first uplink transmission in a first time period and a second uplink transmission in a second time period;
receiving control information indicating a number of repetitions of the first uplink transmission and the second uplink transmission, wherein the repetitions of the first uplink transmission and the second uplink transmission are to be transmitted from the reconfigurable intelligent surface device;
transmitting the first uplink transmission in the first time period; and
delaying the second uplink transmission based at least in part on the number of repetitions of the first uplink transmission.

20. The method of claim 14, further comprising:
transmitting a transmit power value to the reconfigurable intelligent surface device based at least in part on at least one of the first number of repetitions of the signal transmission from the base station having a different receive power than at least one of the second number of repetitions of the signal transmission from the reconfigurable intelligent surface device.

21. The method of claim 14, further comprising:
transmitting an activation signal to the reconfigurable intelligent surface device based at least in part on the UE being unable to decode the signal transmission, wherein the second number of repetitions of the signal transmission from the reconfigurable intelligent surface device are received in response to the activation signal.

22. The method of claim 14, wherein the first number of repetitions of the signal transmission from the base station and the second number of repetitions of the signal transmission from the reconfigurable intelligent surface device are associated with different layers of a multi-layer transmission, further comprising:
receiving information identifying one or more layers of the multi-layer transmission associated with the second number of repetitions of the signal transmission from the reconfigurable intelligent surface device.

23. The method of claim 14, further comprising:
receiving information indicating whether the apparatus is to transmit an activation signal to the reconfigurable intelligent surface device or a negative acknowledgement (NACK) to the base station if the apparatus is unable to decode the signal transmission.

24. An apparatus for wireless communication, comprising:
a reconfigurable intelligent surface;
at least one receiver and at least one transmitter;
a memory; and
at least one processor coupled to the memory and configured to:
receive a first number of repetitions of a signal transmission from a base station; and
transmit a second number of repetitions of the signal transmission to a user equipment (UE) via the reconfigurable intelligent surface.

25. The apparatus of claim 24, wherein the at least one processor is further configured to:
store one or more of the first number of repetitions of the signal transmission from the base station; and
generate the second number of repetitions of the signal transmission based at least in part on the stored one or more of the first number of repetitions of the signal transmission.

26. The apparatus of claim 24, wherein the at least one processor is further configured to:
apply a first reflection configuration for the reconfigurable intelligent surface when the first number of repetitions of the signal transmission are received from the base station; and
apply a second reflection configuration for the reconfigurable intelligent surface when the second number of repetitions of the signal transmission are transmitted to the UE.

27. The apparatus of claim 24, wherein the at least one processor is further configured to:
receive control information including:
a repetition pattern indication associated with the first number of repetitions of the signal transmission from the base station and the second number of repetitions of the signal transmission,
wherein the second number of repetitions of the signal transmission are transmitted based at least in part on the repetition pattern.

28. The apparatus of claim 24, wherein the at least one processor is further configured to:
receive control information including a first value indicating the first number of repetitions of the signal transmission from the base station, and a second value indicating the second number of repetitions of the signal transmission.

29. The apparatus of claim 24, wherein the at least one processor is further configured to:
receive an activation signal from the UE, wherein at least one of the second number of repetitions of the signal transmission is transmitted in response to the activation signal.

30. A method of wireless communication for a reconfigurable intelligent surface (RIS) device, comprising:
receiving a first number of repetitions of a signal transmission from a base station; and
transmitting a second number of repetitions of the signal transmission to a user equipment (UE) via the reconfigurable intelligent surface.
